(19) United States
(12) Patent Application Publication
(10) Pub. No.: US 2026/0091591 A1
(43) Pub. Date: Apr. 2, 2026

(54) LIQUID EJECTION HEAD, LIQUID EJECTION APPARATUS, AND METHOD FOR CONTROLLING LIQUID EJECTION HEAD

(71) Applicant: CANON KABUSHIKI KAISHA, Tokyo (JP)

(72) Inventors: AYAKO IWASAKI, Kanagawa (JP); YOSHIYUKI NAKAGAWA, Kanagawa (JP); TAKASHI KATO, Kanagawa (JP)

(21) Appl. No.: 19/343,279

(22) Filed: Sep. 29, 2025

(30) Foreign Application Priority Data
Sep. 30, 2024 (JP) 2024-170891

(51) Int. Cl. B41J 2/175; B41J 2/045; B41J 2/14

(52) U.S. Cl. CPC B41J 2/17596; B41J 2/0458; B41J 2/1404; B41J 2/1408; B41J 2/14145; B41J 2/1433; B41J 2202/08; B41J 2202/12

(57) ABSTRACT

A liquid ejection head configured to eject a liquid from an ejection port while moving in a predetermined direction includes: an ejection unit including an ejection element for generating energy for ejecting the liquid from the ejection port, a pressure chamber communicating with the ejection port, an individual supply channel for supplying the liquid to the pressure chamber, an individual collection channel for collecting the liquid from the pressure chamber, and a liquid sending element disposed between the individual supply channel and the individual collection channel and configured to send the liquid from the individual supply channel to the individual collection channel; and a circulation unit fluidly connected to the ejection unit and configured to circulate the liquid in a common supply channel for commonly supplying the liquid to a plurality of the individual supply channels, wherein the circulation unit is driven on demand based on a predetermined condition determination.

### BACKGROUND

### Field of the Technology

The present disclosure relates to a liquid ejection head, a liquid ejection apparatus including the liquid ejection head, and a method for controlling the liquid ejection head.

### Description of the Related Art

One of the factors that reduces image quality in liquid ejection heads of the related art is the concentration of ink (liquid). In ejection ports not used for ejection for a while, the ink evaporates from the ejection ports, causing the ink to thicken. As the ink thickens, the ejection volume and ejection direction may vary, in which case streaks and uneven density appear in an image, causing the image quality to deteriorate.

The specification of U.S. Patent Application Publication No. 2020/0238708 (referred to as Document 1) discloses a configuration in which ink is circulated between a liquid ejection head and a main body, using a main body side pump outside the liquid ejection head, in addition to a configuration in which the ink is circulated by an individual pump disposed in a pressure chamber.

However, in Document 1, an external pump that is constantly driven may cause more evaporation from ejection ports than necessary.

### SUMMARY

In view of the above problems, the present disclosure aims to provide a liquid ejection head capable of achieving adequate circulation efficiency while suppressing evaporation from ejection ports.

A liquid ejection head of the present disclosure is a liquid ejection head configured to eject a liquid from an ejection port while moving in a predetermined direction, including: an ejection unit including an ejection element configured to generate energy for ejecting the liquid from the ejection port, a pressure chamber communicating with the ejection port, an individual supply channel for supplying the liquid to the pressure chamber, an individual collection channel for collecting the liquid from the pressure chamber, and a liquid sending element disposed between the individual supply channel and the individual collection channel and configured to send the liquid from the individual supply channel to the individual collection channel; and a circulation unit fluidly connected to the ejection unit and configured to circulate the liquid in a common supply channel for commonly supplying the liquid to a plurality of the individual supply channels, wherein the circulation unit is driven on demand based on a predetermined condition determination.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams illustrating a liquid ejection apparatus.

FIG. 2 is an exploded perspective view of a liquid ejection head.

FIGS. 3A and 3B are a vertical sectional view of the liquid ejection head and an enlarged cross-sectional view of an ejection module.

FIG. 4 is a schematic external view of a circulation unit.

FIG. 5 is a vertical sectional view illustrating a circulation path.

FIG. 6 is a block diagram schematically illustrating the circulation path.

FIGS. 7A to 7C are cross-sectional views illustrating an example of a pressure adjustment unit.

FIGS. 8A and 8B are external perspective views of a circulating pump.

FIG. 9 is a cross-sectional view taken along line IX-IX of the circulating pump illustrated in FIG. 8A.

FIGS. 10A to 10E are diagrams illustrating the flow of ink in the liquid ejection head.

FIGS. 11A and 11B are schematic views illustrating a circulation path in an ejection unit.

FIG. 12 is a view illustrating an opening plate 330.

FIG. 13 is a view illustrating an ejection element substrate.

FIGS. 14A to 14C are cross-sectional views illustrating an ink flow in the ejection unit.

FIGS. 15A and 15B are cross-sectional views illustrating the vicinity of an ejection port.

FIGS. 16A and 16B are cross-sectional views illustrating a comparative example of the vicinity of the ejection port.

FIG. 17 is a view illustrating a comparative example of the ejection element substrate.

FIGS. 18A and 18B are views illustrating a flow channel configuration of the liquid ejection head.

FIG. 19 is a diagram illustrating a connection state between the main body of the liquid ejection apparatus and the liquid ejection head.

FIGS. 20A and 20B are views illustrating a part of an ejection module according to a first embodiment.

FIG. 21 is a diagram illustrating a driving pulse for a liquid sending element.

FIGS. 22A and 22B are views illustrating a part of an ejection module according to a second embodiment.

FIGS. 23A and 23B are views illustrating a part of an ejection module according to a third embodiment.

FIGS. 24A and 24B are views illustrating a part of an ejection module according to a fourth embodiment.

FIGS. 25A to 25C are views illustrating a part of an ejection module according to a fifth embodiment.

### DESCRIPTION OF THE EMBODIMENTS

Embodiments of the present disclosure will be described below with reference to the drawings. The embodiments can be implemented in any configuration, including, but not limited to, other configurations.

A preferred embodiment of the present disclosure will be described in detail with reference to the attached drawings. The following embodiment does not limit the subject matter of the present disclosure, and not all combinations of features described in the present embodiment are necessarily essential to the solution of the present disclosure. The same components will be denoted by the same reference numerals. The present embodiment will be described using, but not limited to, an example where a thermal method is adopted in which an electrothermal converting element generates bubbles to eject a liquid as an ejection element for ejecting the liquid. The present disclosure is also applicable to an ejection method for ejecting a liquid using a piezoelectric element (piezo), or a liquid ejection head using another ejection method. A pump, a pressure adjustment unit, and the like described below are not limited to configurations described in the embodiments and drawings. In the following description, a basic configuration of the present disclosure will be described first, and then the features of the present disclosure will be described.

### Liquid Ejection Apparatus

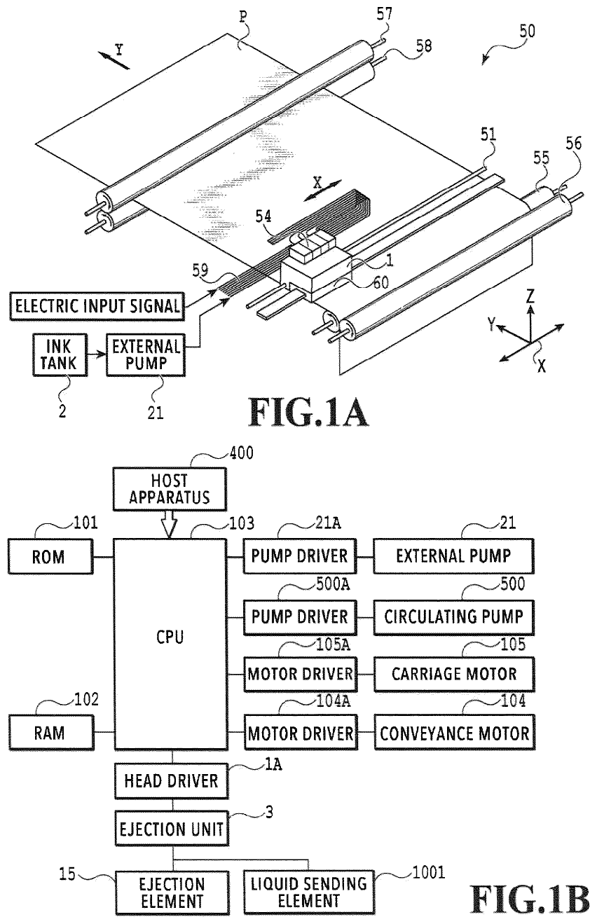

FIGS. 1A and 1B are diagrams for explaining a liquid ejection apparatus, and are enlarged views of a liquid ejection head of the liquid ejection apparatus and its surroundings. First, a schematic configuration of a liquid ejection apparatus 50 according to the present embodiment will be described with reference to FIGS. 1A and 1B. FIG. 1A is a perspective view schematically illustrating the liquid ejection apparatus using a liquid ejection head 1. The liquid ejection apparatus 50 according to the present embodiment constitutes a serial inkjet printing apparatus configured to perform printing on a print medium P by ejecting ink as a liquid while scanning the liquid ejection head 1.

The liquid ejection head 1 is mounted on a carriage 60. The carriage 60 reciprocally moves along a guide shaft 51 in a main scanning direction (X direction). The sheet-shaped print medium P is conveyed in a sub-scanning direction (Y direction) intersecting with (in this example, orthogonal to) the main scanning direction by conveyance rollers 55, 56, 57, and 58. In each of the drawings referred to below, a Z direction indicates a vertical direction, and intersects with (in this example, is orthogonal to) the X-Y plane defined by the X and Y directions. The liquid ejection head 1 is configured to be detachable from and attachable to the carriage 60 by a user.

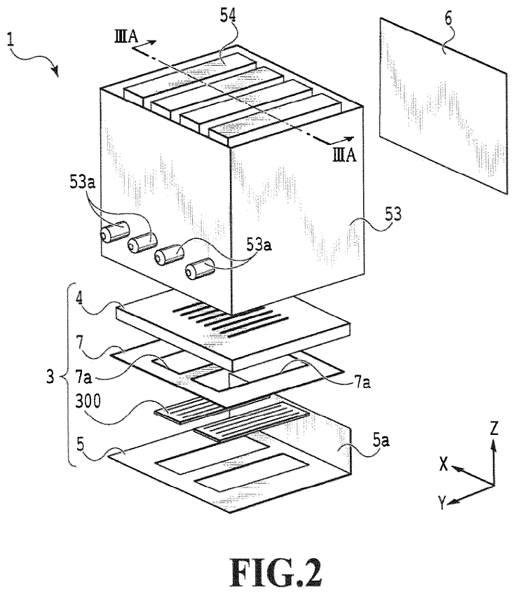

The liquid ejection head 1 includes a circulation unit 54 and an ejection unit 3 (see FIG. 2) to be described later. Although will be described later for its specific configuration, the ejection unit 3 includes a plurality of ejection ports and an energy generating element (hereinafter referred to as ejection element) for generating ejection energy to eject the liquid from each ejection port.

The liquid ejection apparatus 50 is also provided with an ink tank 2 as an ink supply source and an external pump 21. The ink stored in the ink tank 2 is supplied to the circulation unit 54 via an ink supply tube 59 by the driving force of the external pump 21.

The liquid ejection apparatus 50 forms a predetermined image on the print medium P by repeating a printing scan in which the liquid ejection head 1 mounted on the carriage 60 performs printing by ejecting the ink while moving in the main scanning direction, and a conveyance operation of conveying the print medium P in the sub-scanning direction. The liquid ejection head 1 according to the present embodiment is capable of ejecting four types of inks, namely black (B), cyan (C), magenta (M), and yellow (Y) inks, and printing full-color images with these inks. Here, the inks ejectable from the liquid ejection head 1 are not limited to the above four types of inks. The present disclosure is also applicable to liquid ejection heads for ejecting other types of inks. In short, the types and number of inks to be ejected from the liquid ejection head are not limited.

Also, in the liquid ejection apparatus 50, a cap member (not illustrated) capable of covering an ejection port surface of the liquid ejection head in which its ejection ports are formed is provided at a position separated from the conveyance path for the print medium P in the X direction. The cap member covers the ejection port surface of the liquid ejection head 1 during a non-print operation, and is used for prevention of drying of the ejection ports, protection of the ejection ports, an ink suction operation from the ejection ports, and the like.

Note that the liquid ejection head 1 illustrated in FIG. 1A represents an example where four circulation units 54 corresponding to the four types of inks are included in the liquid ejection head 1, but it suffices that the circulation units 54 included correspond to the types of liquids to be ejected. Also, a plurality of circulation units 54 may be included for the same type of liquid. In sum, the liquid ejection head 1 can have a configuration including one or more circulation units. The liquid ejection head 1 may be configured not to circulate all of the four types of inks but only circulate at least one of the inks.

FIG. 1B is a block diagram illustrating a control system of the liquid ejection apparatus 50. A CPU 103 functions as a control unit configured to control the operation of each unit of the liquid ejection apparatus 50 based on a program such as a process procedure stored in a ROM 101. A RAM 102 is used as a work area or the like for the CPU 103 to execute processes. The CPU 103 receives image data from a host apparatus 400 outside the liquid ejection apparatus 50 and controls a head driver 1A to control the driving of an ejection element 15 and a liquid sending element 1001 provided in the ejection unit 3. The CPU 103 also controls various drivers provided in the liquid ejection apparatus. For example, the CPU 103 controls a motor driver 105A for a carriage motor 105 for moving the carriage 60, a motor driver 104A for a conveyance motor 104 for conveying the print medium P, and the like. Moreover, the CPU 103 controls a pump driver 500A for driving a circulating pump 500 to be described later, a pump driver 21A for the external pump 21, and the like. Note that FIG. 1B illustrates a configuration in which the image data is received from the host apparatus 400 and processes are performed, but the liquid ejection apparatus 50 may perform the processes regardless of whether data is given from the host apparatus 400.

### Basic Configuration of Liquid Ejection Head

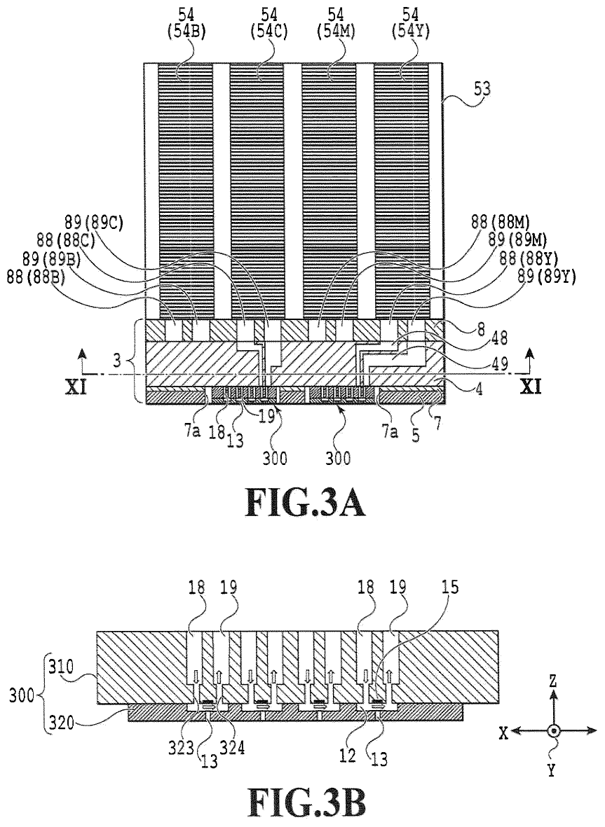

FIG. 2 is an exploded perspective view of the liquid ejection head 1 according to the present embodiment. FIGS. 3A and 3B are cross-sectional views of the liquid ejection head 1 illustrated in FIG. 2 along the line IIIA-IIIA. FIG. 3A is a vertical sectional view of the entire liquid ejection head 1, and FIG. 3B is an enlarged view of an ejection module illustrated in FIG. 3A. A basic configuration of the liquid ejection head 1 in the present embodiment will be described below with reference mainly to FIGS. 2 to 3B and to FIGS. 1A and 1B as appropriate.

As illustrated in FIG. 2, the liquid ejection head 1 includes the circulation units 54 and the ejection unit 3 for ejecting the inks supplied from the circulation units 54 onto the print medium P. The liquid ejection head 1 in the present embodiment is fixedly supported on the carriage 60 of the liquid ejection apparatus 50 by a positioning unit and electric contacts (not illustrated) which are provided to the carriage 60. The liquid ejection head 1 performs printing on the print medium P by ejecting the inks while moving along with the carriage 60 in the main scanning direction (X direction) illustrated in FIG. 1A.

The external pumps 21 connected to the ink tanks 2 serving as ink supply sources include the ink supply tubes 59 (see FIG. 1A). A liquid connector (not illustrated) is provided at the tip of each of these ink supply tubes 59. In the state where the liquid ejection head 1 is mounted to the liquid ejection apparatus 50, the liquid connectors provided at the tips of the ink supply tubes 59 are hermetically connected to liquid connector insertion slots 53a that are inlets provided on a head housing 53 of the liquid ejection head 1. As a result, ink supply paths extending from the ink tanks 2 to the liquid ejection head 1 through the external pumps 21 are formed. In the present embodiment, four types of inks are used. Hence, four sets each including an ink tank 2, an external pump 21, an ink supply tube 59, and a circulation unit 54 are provided for the respective inks, and four ink supply paths corresponding to the respective inks are formed independently of each other. As described above, the liquid ejection apparatus 50 in the present embodiment includes ink supply systems to which the inks are supplied from the ink tanks 2 provided outside the liquid ejection head 1. Note that the liquid ejection apparatus 50 in the present embodiment does not include ink collection systems for collecting the inks in the liquid ejection head 1 into the ink tanks 2. Accordingly, the liquid ejection head 1 includes the liquid connector insertion slots 53a to connect the ink supply tubes 59 of the ink tanks 2, but does not include connector insertion slots to connect tubes for collecting the inks in the liquid ejection head 1 into the ink tanks 2. Note that the liquid connector insertion slot 53a is provided for each ink.

In FIG. 3A, reference numerals 54B, 54C, 54M, and 54Y denote the circulation units for the black, cyan, magenta, and yellow inks, respectively. The circulation units have substantially the same configuration, and each circulation unit will be denoted as “circulation unit 54” in the present embodiment unless otherwise distinguished.

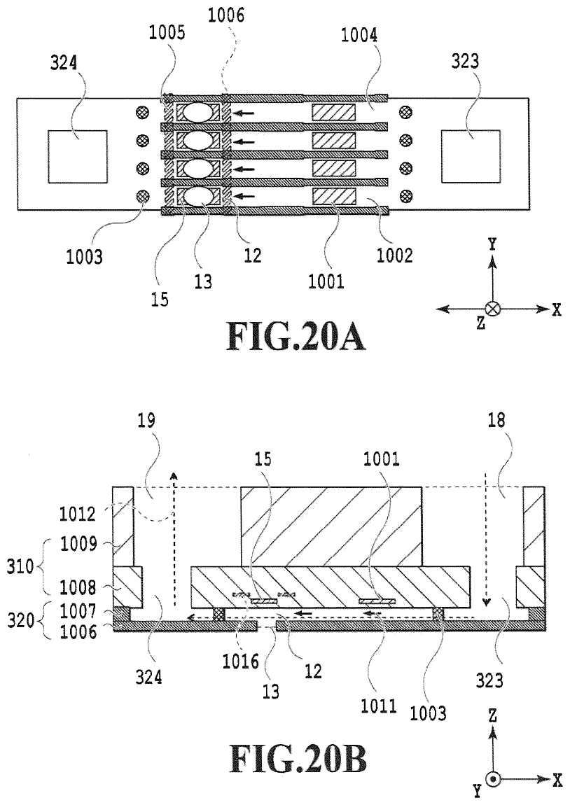

In FIGS. 2 and 3A, the ejection unit 3 includes two ejection modules 300, a first support member 4, a second support member 7, an electric wiring member (electric wiring tape) 5, and an electric contact substrate 6. As illustrated in FIG. 3B, each ejection module 300 includes a silicon substrate 310 with a thickness of 0.5 mm to 1 mm and a plurality of ejection elements 15 provided in one surface of the silicon substrate 310. Although not illustrated in FIG. 3B, the silicon substrate 310 also includes a plurality of liquid sending elements 1001 to be described later (see FIGS. 20A and 20B). The ejection element 15 in the present embodiment includes an electrothermal conversion element (heater) that generates thermal energy as ejection energy for ejecting the liquid. Electric power through an electric wiring formed on the silicon substrate 310 by a film forming technique is supplied to each of the ejection elements 15.

Also, an ejection port forming member 320 is formed on a surface of the silicon substrate 310 (the lower surface in FIG. 3B). In the ejection port forming member 320, a plurality of pressure chambers 12 corresponding to the plurality of ejection elements 15 and a plurality of ejection ports 13 to eject the inks are formed by a photolithographic technique. Moreover, common supply channels 18 and common collection channels 19 are formed in the silicon substrate 310. Furthermore, in the silicon substrate 310, there are formed supply connection channels 323 through which the common supply channels 18 and the pressure chambers 12 communicate with one another, and collection connection channels 324 through which the common collection channels 19 and the pressure chambers 12 communicate with one another. In the present embodiment, one ejection module 300 is configured to eject two types of inks. Specifically, in the two ejection modules 300 illustrated in FIG. 3A, the ejection module 300 located on the left side in FIG. 3A ejects the black and cyan inks, and the ejection module 300 located on the right side in FIG. 3Aejects the magenta and yellow inks. Note that this combination is a mere example, and any combination of inks may be employed. The configuration may be such that one ejection module ejects one type of ink or ejects three or more types of inks. The two ejection modules 300 do not have to eject the same number of types of inks. The configuration may be such that only one ejection module 300 is included, or three or more ejection modules 300 are included. Moreover, in the example illustrated in FIGS. 3A and 3B, two ejection port arrays extending in the Y direction are formed for an ink of one color. A pressure chamber 12, a common supply channel 18, and a common collection channel 19 are formed for each of the plurality of ejection ports 13 forming each ejection port array.

Ink supply ports and ink collection ports to be described later are formed on the back surface (the upper surface in FIG. 3B) side of the silicon substrate 310. Through the ink supply ports, the inks are supplied into the plurality of common supply channels 18 from ink supply channels 48. Through the ink collection ports, the inks are collected into ink collection channels 49 from the plurality of common collection channels 19.

Note that the ink supply ports and the ink collection ports correspond to openings for supplying and collecting the inks during forward ink circulation to be described later, respectively. Specifically, during the forward ink circulation, the inks are supplied from the ink supply ports into the common supply channels 18, and the inks are collected from the common collection channels 19 into the ink collection ports. Note that ink circulation in which the inks are caused to flow in the opposite direction may also be performed. In this case, the inks are supplied from the above-described ink collection ports into the common collection channels 19, and the inks are collected from the common supply channels 18 into the ink supply ports.

As illustrated in FIG. 3A, the back surfaces (the upper surfaces in FIG. 3A) of the ejection modules 300 are adhesively fixed to one surface of the first support member 4 (the lower surface in FIG. 3A). The ink supply channels 48 and the ink collection channels 49, which penetrate from one surface of the first support member 4 to the opposite surface of the first support member 4, are formed in the first support member 4. The openings of the ink supply channels 48 on one side communicate with the above mentioned ink supply ports in the silicon substrate 310. The openings of the ink collection channels 49 on the one side communicate with the above-mentioned ink collection ports in the silicon substrate 310. Note that the ink supply channels 48 and the ink collection channels 49 are provided independently for each type of ink.

Also, a second support member 7 having openings 7a (see FIG. 2) to insert the ejection modules 300 are adhesively fixed to one surface (the upper surface in FIG. 3A) of the first support member 4. The electric wiring member 5 to be electrically connected to the ejection modules 300 is held on the second support member 7. The electric wiring member 5 is a member for applying electric signals for ink ejection to the ejection modules 300. The electric connection parts of the ejection modules 300 and the electric wiring member 5 are sealed with a sealant (not illustrated) to be protected from corrosion by the inks and external impacts.

Also, the electric contact substrate 6 is joined to an end portion 5a of the electric wiring member 5 (see FIG. 2) by thermocompression bonding with an anisotropic conductive film (not illustrated), and the electric wiring member 5 and the electric contact substrate 6 are electrically connected to each other. The electric contact substrate 6 has external signal input terminals (not illustrated) for receiving electric signals from the liquid ejection apparatus 50.

Moreover, a joint member 8 (FIG. 3A) is provided between the first support member 4 and the circulation units 54. In the joint member 8, a supply port 88 and a collection port 89 are formed for each type of ink. Through the supply ports 88 and the collection ports 89, the ink supply channels 48 and the ink collection channels 49 in the first support member 4 and channels formed in the circulation units 54 communicate with each other. In FIG. 3A, a supply port 88B and a collection port 89B are for the black ink, and a supply port 88C and a collection port 89C are for the cyan ink. Moreover, a supply port 88M and a collection port 89M are for the magenta ink, and a supply port 88Y and a collection port 89Y are for the yellow ink.

Note that the openings at one end of the ink supply channels 48 and the ink collection channels 49 in the first support member 4 have small opening areas matching the ink supply ports and the ink collection ports in the silicon substrate 310. On the other hand, the openings at the other end of the ink supply channels 48 and the ink collection channels 49 in the first support member 4 have a large shape whose opening area is the same opening area formed in the joint member 8 to match the channels in the circulation units 54. Employing such a configuration can suppress an increase in channel resistance on the ink collected from each collection channel. Note that the shapes of the openings at one end and the other end of the ink supply channels 48 and the ink collection channels 49 are not limited to the above example.

In the liquid ejection head 1 having the above configuration, the inks supplied to the circulation units 54 pass through the supply ports 88 in the joint member 8 and the ink supply channels 48 in the first support member 4 and flow into the common supply channels 18 from the ink supply ports in the ejection modules 300. Thereafter, the inks flow from the common supply channels 18 into the pressure chambers 12 through the supply connection channels 323. Part of the inks flowing into the pressure chambers is ejected from the ejection ports 13 as the ejection elements 15 are driven. The remaining inks not ejected pass through the collection connection channels 324 and the common collection channels 19 from the pressure chambers 12, and flow from the ink collection ports into the ink collection channels 49 in the first support member 4. Then, the inks flowing into the ink collection channels 49 flow into the circulation units 54 through the collection ports 89 in the joint member 8 and are collected.

### Constituent Elements of Circulation Unit

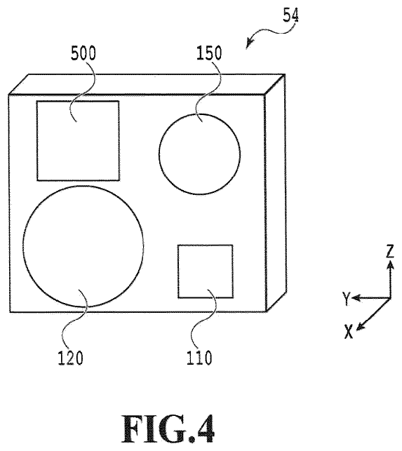

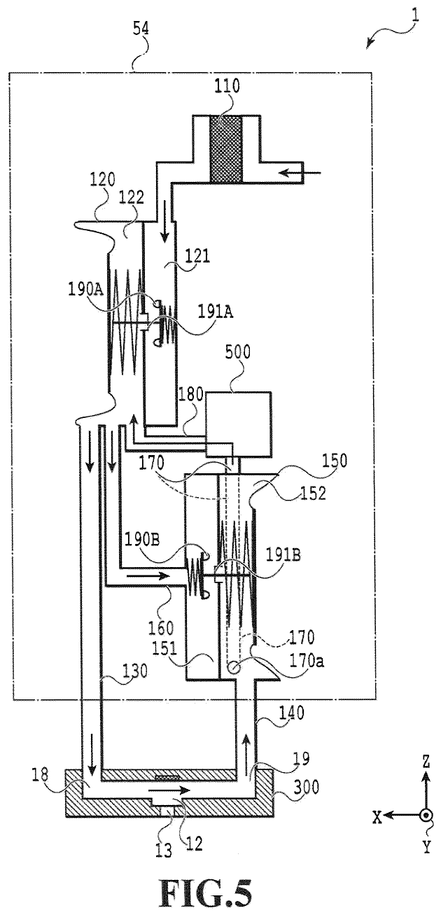

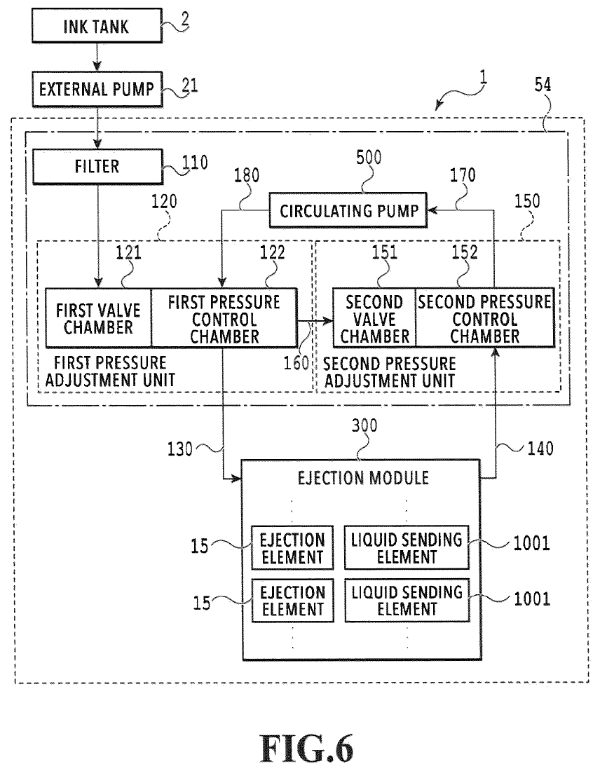

FIG. 4 is a schematic external view of one circulation unit 54 for one type of ink used in a printing apparatus according to the present embodiment. A filter 110, a first pressure adjustment unit 120, a second pressure adjustment unit 150, and a circulating pump 500 are disposed in the circulation unit 54. As illustrated in FIGS. 5 and 6, these constituent elements are connected by channels to form a circulation path for supplying and collecting the ink to and from the ejection module 300 in the liquid ejection head 1.

### Circulation Path in Liquid Ejection Head

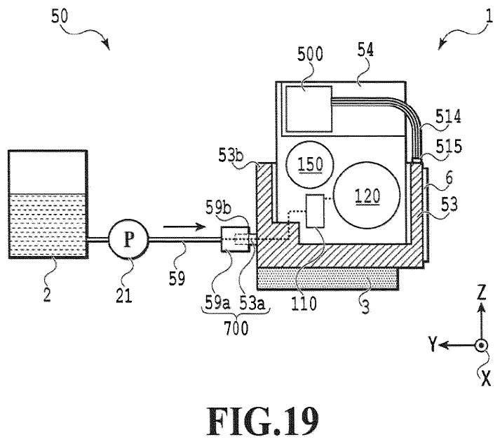

FIG. 5 is a vertical sectional view schematically illustrating the circulation path for one type of ink (ink of one color) formed in the liquid ejection head 1. The relative positions of the components in FIG. 5 (such as the first pressure adjustment unit 120, the second pressure adjustment unit 150, and the circulating pump 500) are simplified for a clearer description of the circulation path. Thus, the relative positions of the components are different from those of the components in FIG. 19 to be described later. Incidentally, FIG. 6 is a block diagram schematically illustrating the circulation path illustrated in FIG. 5. As illustrated in FIGS. 5 and 6, the first pressure adjustment unit 120 includes a first valve chamber 121 and a first pressure control chamber 122. The second pressure adjustment unit 150 includes a second valve chamber 151 and a second pressure control chamber 152. The first pressure adjustment unit 120 is configured such that the controlled pressure therein is higher than that in the second pressure adjustment unit 150. In the present embodiment, these two pressure adjustment units 120 and 150 are used to implement circulation within a certain pressure range inside the circulation path. Also, the configuration is such that the ink flows through the pressure chambers 12 (ejection elements 15) at a flow rate corresponding to the pressure difference between the first pressure adjustment unit 120 and the second pressure adjustment unit 150. A circulation path in the liquid ejection head 1 and a flow of the ink in the circulation path will be described below with reference to FIGS. 5 and 6. Note that the arrows in FIGS. 5 and 6 indicate the flow direction of the ink.

First, how the constituent elements in the liquid ejection head 1 are connected will be described.

The external pump 21, which sends the ink stored in the ink tank 2 (see FIG. 6) disposed outside the liquid ejection head 1 to the liquid ejection head 1, is connected to the circulation unit 54 through the ink supply tube 59 (see FIG. 1A). The filter 110 is disposed in the ink channel located on the upstream side of the circulation unit 54. The ink supply path located on the downstream side of the filter 110 is connected to the first valve chamber 121 of the first pressure adjustment unit 120. The first valve chamber 121 communicates with the first pressure control chamber 122 through a communication port 191A openable and closable by a valve 190A illustrated in FIG. 5.

The first pressure control chamber 122 is connected to a supply channel 130, a bypass channel 160, and a pump outlet channel 180 of the circulating pump 500. The supply channel 130 is connected to the common supply channels 18 through the above-mentioned ink supply ports provided in the ejection module 300. The bypass channel 160 is connected to the second valve chamber 151 provided in the second pressure adjustment unit 150. The second valve chamber 151 communicates with the second pressure control chamber 152 through a communication port 191B that is opened and closed by a valve 190B illustrated in FIG. 5. Note that FIGS. 5 and 6 illustrate an example where one end of the bypass channel 160 is connected to the first pressure control chamber 122 of the first pressure adjustment unit 120, and the other end of the bypass channel 160 is connected to the second valve chamber 151 of the second pressure adjustment unit 150. However, the one end of the bypass channel 160 may be connected to the supply channel 130, and the other end of the bypass channel may be connected to the second valve chamber 151.

The second pressure control chamber 152 is connected to a collection channel 140. The collection channel 140 is connected to the common collection channels 19 through the above-mentioned ink collection ports provided in the ejection module 300. The second pressure control chamber 152 is also connected to the circulating pump 500 through a pump inlet channel 170. Note that reference numeral 170a in FIG. 5 denotes an inlet port of the pump inlet channel 170.

Next, the flow of the ink in the liquid ejection head 1 having the above configuration will be described. As illustrated in FIG. 6, the ink stored in the ink tank 2 is pressurized by the external pump 21 provided in the liquid ejection apparatus 50, becomes an ink flow at a positive pressure, and is supplied to the circulation unit 54 of the liquid ejection head 1.

The ink supplied to the circulation unit 54 passes through the filter 110 so that foreign substances such as dust and bubbles are removed. The ink then flows into the first valve chamber 121 provided in the first pressure adjustment unit 120. The pressure on the ink decreases due to the pressure loss in a case where the ink passes through the filter 110, but the pressure on the ink is still positive at this point. Thereafter, in a case where the valve 190A is open, the ink flowing into the first valve chamber 121 passes through the communication port 191A and flows into the first pressure control chamber 122. Due to the pressure loss in a case where the ink passes through the communication port 191A, the pressure on the ink flowing into the first pressure control chamber 122 switches from the positive pressure to a negative pressure.

Next, the flow of the ink in the circulation path will be described. The circulating pump 500 operates such that the ink sucked from the pump inlet channel 170 located on the upstream side of the circulating pump 500 is sent to the pump outlet channel 180 located on the downstream side of the circulating pump 500. Thus, as the pump is driven, the ink supplied to the first pressure control chamber 122 flows into the supply channel 130 and the bypass channel 160 along with the ink sent from the pump outlet channel 180. In the present embodiment, while details will be described later, a piezoelectric diaphragm pump using a piezoelectric element attached to a diaphragm as a driving source is used as a circulating pump capable of sending the liquid. The piezoelectric diaphragm pump is a pump that sends a liquid by inputting a driving voltage to a piezoelectric element to change the volume of a pump chamber and alternatively moving two check valves in response to the changes in pressure.

The ink flowing into the supply channel 130 flows from the ink supply ports in the ejection module 300 into the pressure chambers 12 through the common supply channels 18. Part of the ink is ejected from the ejection ports 13 as the ejection elements 15 are driven (generate heat). Also, the remaining ink not used in the ejection flows through the pressure chambers 12 and passes through the common collection channels 19. Thereafter, the ink flows into the collection channel 140 connected to the ejection module 300. The ink flowing into the collection channel 140 flows into the second pressure control chamber 152 of the second pressure adjustment unit 150.

On the other hand, the ink flowing from the first pressure control chamber 122 into the bypass channel 160 flows into the second valve chamber 151, passes through the communication port 191B, and then flows into the second pressure control chamber 152. The ink flowing into the second pressure control chamber 152 through the bypass channel 160 and the ink collected from the collection channel 140 are sucked into the circulating pump 500 through the pump inlet channel 170 as the circulating pump 500 is driven. Then, the inks sucked into the circulating pump 500 are sent to the pump outlet channel 180 and flow into the first pressure control chamber 122 again. Thereafter, the ink flowing from the first pressure control chamber 122 into the second pressure control chamber 152 through the supply channel 130 and the ejection module 300 and the ink flowing into the second pressure control chamber 152 through the bypass channel 160 flow into the circulating pump 500. Then, the inks are sent from the circulating pump 500 to the first pressure control chamber 122. The ink circulation is thus performed within the circulation path.

As described above, in the present embodiment, the liquids can be circulated through the respective circulation paths formed in the liquid ejection head 1 with the circulating pump 500. This makes it possible to suppress thickening of the inks and deposition of precipitating components of the inks of the color materials in the ejection modules 300. Accordingly, the excellent fluidity of the inks in the ejection modules 300 and excellent ejection characteristics at the ejection ports can be maintained.

Also, the circulation paths in the present embodiment are configured to complete within the liquid ejection head 1. Thus, the length of the circulation paths can be significantly shortened as compared to a case where the inks are circulated between the ink tanks 2 disposed outside the liquid ejection head 1 and the liquid ejection head 1. Accordingly, the inks can be circulated with small circulating pumps.

Moreover, the configuration is such that only channels for supplying the inks are included as the channels connecting between the liquid ejection head 1 and the ink tanks 2. In other words, a configuration that does not require channels for collecting the inks from the liquid ejection head 1 into the ink tanks 2 is employed. Accordingly, only ink supply tubes connecting between the ink tanks 2 and the liquid ejection head 1 are needed, and no ink collection tube is required. The inside of the liquid ejection apparatus 50 therefore has a simpler configuration having less tubes. This can downsize the entire apparatus. Moreover, the reduction in the number of tubes can reduce the fluctuations in ink pressure due to the swinging of the tubes caused by main scanning of the liquid ejection head 1. The swinging of the tubes during main scanning of the liquid ejection head 1 increases a driving load on the carriage motor driving the carriage 60. Hence, the reduction in the number of tubes reduces the driving load of the carriage motor, which makes it possible to simplify the main scanning mechanism including the carriage motor and the like. Furthermore, since the inks do not need to be collected into the ink tanks from the liquid ejection head, the external pumps 21 can be downsized as well. As described above, according to the present embodiment, it is possible to downsize the liquid ejection apparatus 50 and reduce costs.

### Pressure Adjustment Unit

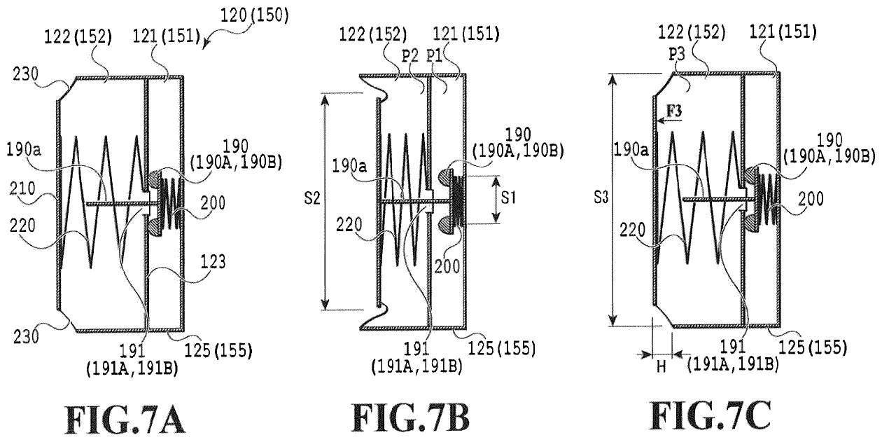

FIGS. 7A to 7C are views illustrating an example of the pressure adjustment units. Configurations and operation of the pressure adjustment units incorporated in the above described liquid ejection head 1 (first pressure adjustment unit 120 and second pressure adjustment unit 150) will be described in more detail with reference to FIGS. 7A to 7C. Note that the first pressure adjustment unit 120 and the second pressure adjustment unit 150 have substantially the same configuration. Thus, the following description will be given by taking the first pressure adjustment unit 120 as an example. As for the second pressure adjustment unit 150, only the reference numerals of its portions corresponding to those of the first pressure adjustment unit are presented in FIGS. 7A to 7C. In a case of the second pressure adjustment unit 150, the first valve chamber 121 and the first pressure control chamber 122 described below should be read as the second valve chamber 151 and the second pressure control chamber 152, respectively.

The first pressure adjustment unit 120 has the first valve chamber 121 and the first pressure control chamber 122 formed in a cylindrical housing 125. The first valve chamber 121 and the first pressure control chamber 122 are separated by a partition 123 provided inside the cylindrical housing 125. However, the first valve chamber 121 communicates with the first pressure control chamber 122 through a communication port 191 formed in the partition 123. A valve 190, which switches between allowing communication between the first valve chamber 121 and the first pressure control chamber 122 through the communication port 191 and blocking the communication, is provided in the first valve chamber 121. The valve 190 is held by a valve spring 200 at a position opposite to the communication port 191, and has a tight contact configuration to the partition 123 by a biasing force from the valve spring 200. The valve 190 blocks the ink flow through the communication port 191 by being in tight contact with the partition 123. Note that the portion of the valve 190 to be in contact with the partition 123 is preferably formed of an elastic member in order to enhance the tightness of the contact with the partition 123. Also, a valve shaft 190a to be inserted through the communication port 191 is provided in a protruding manner on a center portion of the valve 190. By pressing this valve shaft 190a against the biasing force from the valve spring 200, the valve 190 gets separated from the partition 123, thereby allowing the ink to flow through the communication port 191. In the following, the state where the valve 190 blocks the ink flow through the communication port 191 will be referred to as “closed state”, and the state where the ink can flow through the communication port 191 will be referred to as “open state”.

The opening portion of the cylindrical housing 125 is closed by a flexible member 230 and a pressing plate 210. These flexible member 230 and pressing plate 210, the peripheral wall of the housing 125, and the partition 123 form the first pressure control chamber 122. The pressing plate 210 is configured to be displaceable with displacement of the flexible member 230. While the materials of the pressing plate 210 and the flexible member 230 are not particularly limited, for example, the pressing plate 210 can be made as a molded resin component, and the flexible member 230 can be made from a resin film. In this case, the pressing plate 210 can be fixed to the flexible member 230 by thermal welding.

A pressure adjustment spring 220 (biasing member) is provided between the pressing plate 210 and the partition 123. As illustrated in FIG. 7A, the pressing plate 210 and the flexible member 230 are biased by a biasing force from the pressure adjustment spring 220 in a direction in which the inner volume of the first pressure control chamber 122 increases. Also, as the pressure in the first pressure control chamber 122 decreases, the pressing plate 210 and the flexible member 230 get displaced against the pressure from the pressure adjustment spring 220 in the direction in which the inner volume of the first pressure control chamber 122 decreases. Then, in a case where the inner volume of the first pressure control chamber 122 decreases to a certain volume, the pressing plate 210 abuts the valve shaft 190a of the valve 190. As the inner volume of the first pressure control chamber 122 then further decreases, the valve 190 moves with the valve shaft 190a against the biasing force from the valve spring 200, thereby being separated from the partition 123. As a result, the communication port 191 shifts to the open state (the state of FIG. 7B).

In the present embodiment, the connections in the circulation path are set such that the pressure in the first valve chamber 121 in a case where the communication port 191 shifts to the open state is higher than the pressure in the first pressure control chamber 122. In this way, in a case where the communication port 191 shifts to the open state, the ink flows from the first valve chamber 121 into the first pressure control chamber 122. The inflow of the ink displaces the flexible member 230 and the pressing plate 210 in the direction in which the inner volume of the first pressure control chamber 122 increases. As a result, the pressing plate 210 gets separated from the valve shaft 190a of the valve 190, and the valve 190 is brought into tight contact with the partition 123 by the biasing force from the valve spring 200 so that the communication port 191 shifts to the closed state (the state of FIG. 7C).

As described above, in the first pressure adjustment unit 120 in the present embodiment, in a case where the pressure in the first pressure control chamber 122 decreases to a certain pressure or less (for example, in a case where the negative pressure becomes strong), the ink flows from the first valve chamber 121 through the communication port 191. This configuration limits the pressure in the first pressure control chamber 122 from decreasing any further. Accordingly, the pressure in the first pressure control chamber 122 is controlled to be maintained within a certain range.

Next, the pressure in the first pressure control chamber 122 will be described in more detail.

Consider a state where the flexible member 230 and the pressing plate 210 are displaced according to the pressure in the first pressure control chamber 122 as described above so that the pressing plate 210 abuts the valve shaft 190a and brings the communication port 191 into the open state (the state of FIG. 7B). The relation between the forces acting on the pressing plate 210 at this time is represented by Formula 1 below.

P2×S2+F2+(P1−P2)×S1+F1=0 Formula 1

Moreover, Formula 1 is summarized for P2 as below.

P2=−(F1+F2+P1×S1)/(S2−S1) Formula 2
P1: Pressure (gauge pressure) in the first valve chamber 121
P2: Pressure (gauge pressure) in the first pressure control chamber 122
F1: Spring force of the valve spring 200
F2: Spring force of the pressure adjustment spring 220
S1: Pressure reception area of the valve 190
S2: Pressure reception area of the pressing plate 210

Here, as for the spring force F1 of the valve spring 200 and the spring force F2 of the pressure adjustment spring 220, the direction in which they push the valve 190 and the pressing plate 210 is defined as the positive direction (the rightward direction in FIGS. 7A to 7C). Also, the configuration is such that the pressure P1 in the first valve chamber 121 and the pressure P2 in the first pressure control chamber 122 satisfy a relation of P1≥P2.

The pressure P2 in the first pressure control chamber 122 in a case where the communication port 191 shifts to the open state is determined by Formula 2. Since the configuration is such that the relation of P1≥P2 is satisfied, the ink flows into the first pressure control chamber 122 from the first valve chamber 121 as the communication port 191 shifts to the open state. As a result, the pressure P2 in the first pressure control chamber 122 does not decrease any further, and the pressure P2 is kept at a pressure within a certain range.

On the other hand, as illustrated in FIG. 7C, the relation between the forces acting on the pressing plate 210 in a case where the pressing plate 210 does not abut on the valve shaft 190a and the communication port 191 shifts to the closed state is represented by Formula 3 below.

P3×S3+F3=0 Formula 3

Here, Formula 3 is summarized for P3 as below.

P3=−F3/S3 Formula 4
F3: Spring force of the pressure adjustment spring 220 in a state where the pressing plate 210 does not abut on the valve shaft 190a
P3: Pressure (gauge pressure) in the first pressure control chamber 122 in the state where the pressing plate 210 does not abut on the valve shaft 190a
S3: Pressure reception area of the pressing plate 210 in a state where the pressing plate 210 does not abut on the valve 190

Here, FIG. 7C illustrates a state where the pressing plate 210 and the flexible member 230 are displaced in the rightward direction in FIG. 7C up to the limit to which they can be displaced. The pressure P3 in the first pressure control chamber 122, the spring force F3 of the pressure adjustment spring 220, and the pressure reception area S3 of the pressing plate 210 change depending on the amount of displacement of the pressing plate 210 and the flexible member 230 in displacement to the state of FIG. 7C. Specifically, in a case where the pressing plate 210 and the flexible member 230 are situated on the left side in FIG. 7A relative to themselves in FIG. 7C, the pressure reception area S3 of the pressing plate 210 is smaller and the spring force F3 of the pressure adjustment spring 220 is larger. Accordingly, the pressure P3 in the first pressure control chamber 122 is smaller in accordance with the relation in Formula 4. Thus, with Formulas 2 and 4, the pressure in the first pressure control chamber 122 gradually increases (that is, the negative pressure weakens toward a value close to the positive pressure side) in shifting from the state of FIG. 7B to the state of FIG. 7C. Specifically, the pressure in the first pressure control chamber 122 gradually increases while the pressing plate 210 and the flexible member 230 are gradually displaced in the rightward direction from the state where the communication port 191 is in the open state to the state where the inner volume of the first pressure control chamber reaches the limit to which the pressing plate 210 and the flexible member 230 can be displaced. In other words, the negative pressure weakens.

### Circulating Pump

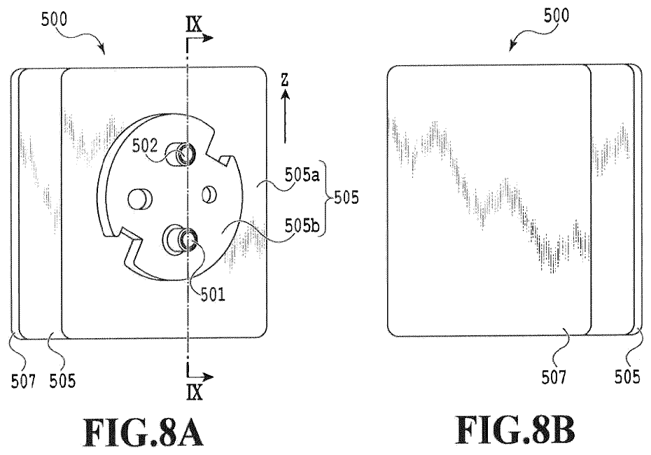

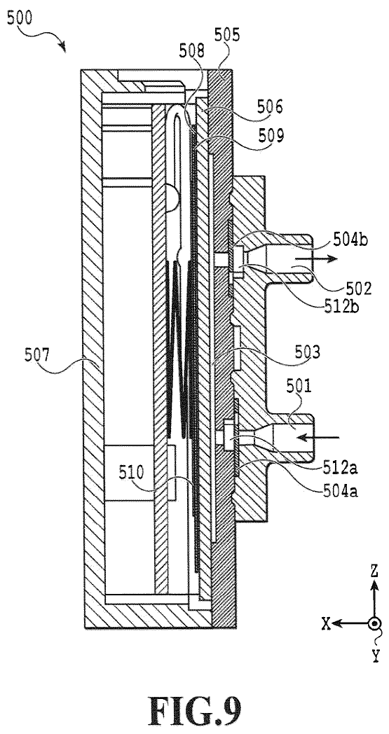

Next, a configuration and operation of each circulating pump 500 incorporated in the above liquid ejection head 1 will be described in detail with reference to FIGS. 8A and 8B and FIG. 9.

FIGS. 8A and 8B are external perspective views of the circulating pump 500. FIG. 8A is an external perspective view illustrating the front side of the circulating pump 500. FIG. 8B is an external perspective view illustrating the back side of the circulating pump 500. An outer shell of the circulating pump 500 includes a pump housing 505 and a cover 507 fixed to the pump housing 505. The pump housing 505 includes a housing-part main body 505a and a channel connection member 505b adhesively fixed to the outer surface of the housing-part main body 505a. In each of the housing-part main body 505a and the channel connection member 505b, a pair of throughholes communicating with each other are formed at two different positions. One of the pair of through-holes provided at one position forms a pump supply hole 501. The other of the pair of through-holes provided at the other position forms a pump discharge hole 502. The pump supply hole 501 is connected to the pump inlet channel 170 connected to the second pressure control chamber 152. The pump discharge hole 502 is connected to the pump outlet channel 180 connected to the first pressure control chamber 122. The ink supplied from the pump supply hole 501 passes through a pump chamber 503 to be described later (see FIG. 9) and is discharged from the pump discharge hole 502.

FIG. 9 is a cross-sectional view of the circulating pump 500 illustrated in FIG. 8A along the line IX-IX. A diaphragm 506 is joined to the inner surface of the pump housing 505, and the pump chamber 503 is formed between this diaphragm 506 and a recess formed in the inner surface of the pump housing 505. The pump chamber 503 communicates with the pump supply hole 501 and the pump discharge hole 502, which are formed in the pump housing 505. Also, a check valve 504a is provided at an intermediate portion of the pump supply hole 501. A check valve 504b is provided at an intermediate portion of the pump discharge hole 502. Specifically, the check valve 504a is disposed such that a part thereof is movable in the leftward direction in FIG. 9 within a space 512a formed at an intermediate portion of the pump supply hole 501. The check valve 504a is disposed such that a part thereof is movable in the rightward direction in FIG. 9 within a space 512b formed at an intermediate portion of the pump discharge hole 502.

As the diaphragm 506 is displaced so as to increase the volume of the pump chamber 503, the pump chamber 503 is depressurized. In response to this displacement, the check valve 504a is separated from the opening of the pump supply hole 501 in the space 512a (that is, moves in the leftward direction in FIG. 9). By being separated from the opening of the pump supply hole 501 in the space 512a, the check valve 504a shifts to an open state in which the ink is allowed to flow through the pump supply hole 501. As the diaphragm 506 is displaced so as to reduce the volume of the pump chamber 503, the pump chamber 503 is pressurized. In response to this displacement, the check valve 504a comes into tight contact with the wall surface around the opening of the pump supply hole 501. The check valve 504a is thus in a closed state in which the check valve 504a blocks the ink flow through the pump supply hole 501.

The check valve 504b, on the other hand, comes into tight contact with the wall surface around an opening in the pump housing 505 as the pump chamber 503 is depressurized, thereby shifting to a closed state in which the check valve 504b blocks the ink flow through the pump discharge hole 502. Also, as the pump chamber 503 is pressurized, the check valve 504b is separated from the opening in the pump housing 505 and moves toward the space 512b (that is, moves in the rightward direction in FIG. 9), thereby allowing the ink to flow through the pump discharge hole 502.

Note that the material of each of the check valves 504a and 504b only needs to be one that is deformable according to the pressure in the pump chamber 503. For example, the material of each of the check valves 504a and 504b can made from an elastic material such as EPDM or an elastomer, or a film or thin plate of polypropylene or the like. However, the material is not limited to these.

As described above, the pump chamber 503 is formed by joining the pump housing 505 and the diaphragm 506. Thus, the pressure in the pump chamber 503 changes as the diaphragm 506 is deformed. For example, in a case where the diaphragm 506 is displaced toward the pump housing 505 (displaced toward the right side in FIG. 9), thereby reducing the volume of the pump chamber 503, the pressure in the pump chamber 503 increases. As a result, the check valve 504b disposed so as to face the pump discharge hole 502 shifts to the open state so that the ink in the pump chamber 503 is discharged. At this time, the check valve 504a disposed so as to face the pump supply hole 501 is in tight contact with the wall surface around the pump supply hole 501, thereby suppressing backflow of the ink from the pump chamber 503 into the pump supply hole 501.

Conversely, in a case where the diaphragm 506 is displaced in the direction in which the pump chamber 503 widens, the pressure in the pump chamber 503 decreases. As a result, the check valve 504a disposed so as to face the pump supply hole 501 shifts to the open state so that the ink is supplied into the pump chamber 503. At this time, the check valve 504b disposed in the pump discharge hole 502 comes into tight contact with the wall surface around an opening formed in the pump housing 505 to close this opening. This suppresses backflow of the ink from the pump discharge hole 502 into the pump chamber 503.

As described above, in the circulating pump 500, the ink is sucked and discharged as the diaphragm 506 is deformed and thereby changes the pressure in the pump chamber 503. At this time, in a case where bubbles have entered the pump chamber 503, the displacement of the diaphragm 506 changes the pressure in the pump chamber 503 to a lesser extent due to the expansion or shrinkage of the bubbles. Accordingly, the amount of the liquid to be sent decreases. To resolve this phenomenon, the pump chamber 503 is disposed in parallel with gravity so that the bubbles having entered the pump chamber 503 can easily gather in an upper portion of the pump chamber 503. In addition, the pump discharge hole 502 is disposed higher than the center of the pump chamber 503. This improves the ease of discharge of bubbles in the pump and thus stabilizes the flow rate.

### Flow of Ink inside Liquid Ejection Head

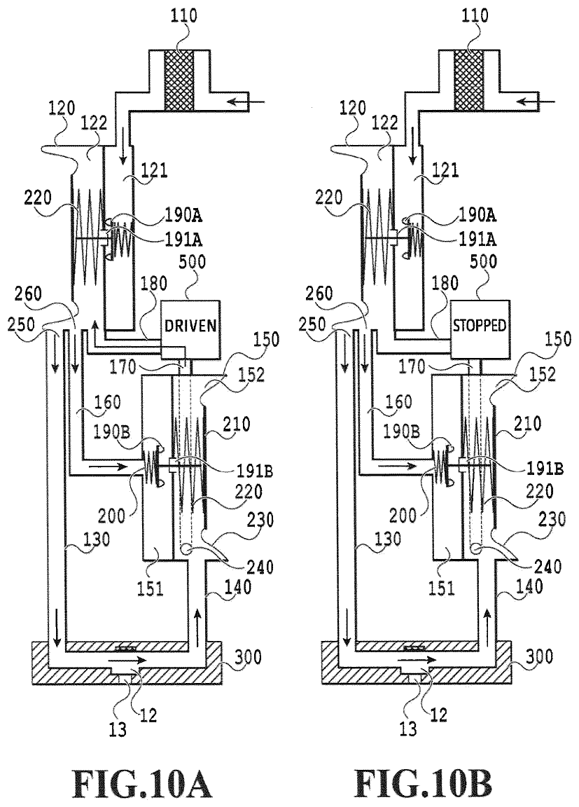

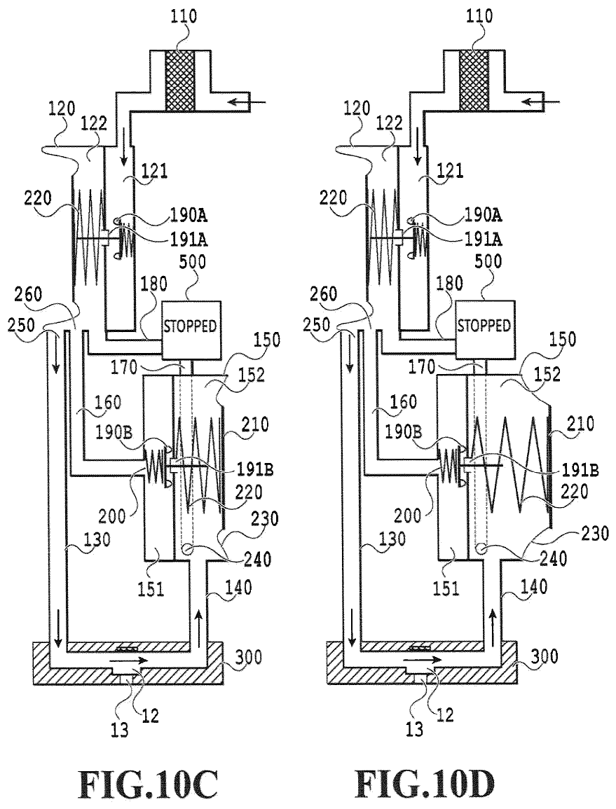

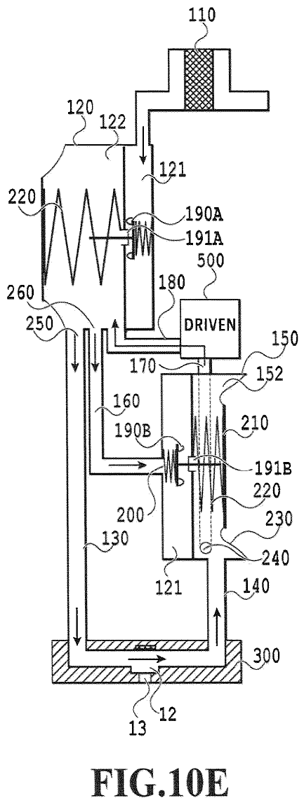

FIGS. 10A to 10E are diagrams describing a flow of an ink inside the liquid ejection head. The circulation of the ink performed inside the liquid ejection head 1 will be described with reference to FIGS. 10A to 10E. The relative positions of the components in FIGS. 10A to 10E (such as the first pressure adjustment unit 120, the second pressure adjustment unit 150, and the circulating pump 500) are simplified for a clearer description of the ink circulation path. Thus, the relative positions of the components are different from those of the components in FIG. 19 to be mentioned later. FIG. 10A schematically illustrates the flow of the ink in a case of performing a print operation of performing printing by ejecting the ink from the ejection ports 13. Note that the arrows in FIG. 10A indicate the flow of the ink. In the present embodiment, to start a print operation, both the external pump 21 and the circulating pump 500 start being driven. The external pump 21 and the circulating pump 500 do not have to be driven in conjunction with each other, and may be driven independently of each other. In the present embodiment, the circulating pump 500 is driven on demand according to the judgment of the CPU 103.

During the print operation, the circulating pump 500 is basically in an ON state (driven state) so that the ink flowing out of the first pressure control chamber 122 flows into the supply channel 130 and the bypass channel 160. The ink having flowed into the supply channel 130 passes through the ejection module 300 and then flows into the collection channel 140. Thereafter, the ink is supplied into the second pressure control chamber 152.

On the other hand, the ink having flowed into the bypass channel 160 from the first pressure control chamber 122 flows into the second pressure control chamber 152 through the second valve chamber 151. The ink having flowed into the second pressure control chamber 152 passes through the pump inlet channel 170, the circulating pump 500, and the pump outlet channel 180 and then flows into the first pressure control chamber 122 again. At this time, based on the relation in Formula 2 mentioned above, the controlled pressure in the first valve chamber 121 is set higher than the controlled pressure in the first pressure control chamber 122. Thus, the ink in the first pressure control chamber 122 does not flow into the first valve chamber 121 but is supplied to the ejection module 300 again through the supply channel 130. The ink having flowed into the ejection module 300 flows into the first pressure control chamber 122 again through the collection channel 140, the second pressure control chamber 152, the pump inlet channel 170, the circulating pump 500, and the pump outlet channel 180. Ink circulation that completes within the liquid ejection head 1 is performed as described above.

In the above ink circulation, the differential pressure between the controlled pressure in the first pressure control chamber 122 and the controlled pressure in the second pressure control chamber 152 determines the amount of circulation (flow rate) of the ink within the ejection module 300. Moreover, this differential pressure is set to obtain an amount of circulation that can suppress thickening of the ink near the ejection ports in the ejection module 300. Incidentally, the amount of the ink consumed by the printing is supplied from the ink tank 2 to the first pressure control chamber 122 through the filter 110 and the first valve chamber 121. How the consumed ink is supplied will now be described in detail. The ink in the circulation path decreases by the amount of the ink consumed by the printing. Accordingly, the pressure in the first pressure control chamber 122 decreases, resulting in decreasing the ink in the first pressure control chamber. As the ink in the first pressure control chamber 122 decreases, the inner volume of the first pressure control chamber 122 decreases accordingly. As this inner volume of the first pressure control chamber 122 decreases, the communication port 191A switches to the open state so that the ink is supplied from the first valve chamber 121 to the first pressure control chamber 122. A pressure loss occurs in this supplied ink as this ink supplied from the first valve chamber 121 passes through the communication port 191A. As the ink flows into the first pressure control chamber 122, the positive pressure on the ink switches to a negative pressure. As the ink flows from the first valve chamber 121 into the first pressure control chamber 122, the pressure in the first pressure control chamber increases. The communication port 191A shifts to the closed state as the inner volume of the first pressure control chamber increases. As described above, the communication port 191A repetitively switches between the open state and the closed state according to the ink consumption. Incidentally, the communication port 191A is kept in the closed state in a case where the ink is not consumed.

FIG. 10B schematically illustrates the flow of the ink immediately after the circulating pump 500 shifts to an OFF state (stop state). At the point when the circulating pump 500 shifts to the OFF state, the pressure in the first pressure control chamber 122 and the pressure in the second pressure control chamber 152 are both the controlled pressures used in the print operation. For this reason, the ink moves as illustrated in FIG. 10B according to the differential pressure between the pressure in the first pressure control chamber 122 and the pressure in the second pressure control chamber 152. Specifically, the ink flow from the first pressure control chamber 122 to the ejection module 300 through the supply channel 130 and then to the second pressure control chamber 152 through the collection channel 140 continues to be generated. Moreover, the ink flow from the first pressure control chamber 122 to the second pressure control chamber 152 through the bypass channel 160 and the second valve chamber 151 continues to be generated.

The amount of the ink moved from the first pressure control chamber 122 to the second pressure control chamber 152 by these ink flows is supplied from the ink tank 2 to the first pressure control chamber 122 through the filter 110 and the first valve chamber 121. Accordingly, the inner volume of the first pressure control chamber 122 is maintained constant. According to the relation in Formula 2 mentioned above, the spring force F1 of the valve spring 200, the spring force F2 of the pressure adjustment spring 220, the pressure reception area S1 of the valve 190, and the pressure reception area S2 of the pressing plate 210 are maintained constant in a case where the inner volume of the first pressure control chamber 122 is constant. Thus, the pressure in the first pressure control chamber 122 is determined depending on the change of the pressure (gauge pressure) P1 in the first valve chamber 121. Therefore, in a case where the pressure P1 in the first valve chamber 121 does not change, the pressure P2 in the first pressure control chamber 122 is maintained at the same pressure as the controlled pressure in the print operation.

On the other hand, the pressure in the second pressure control chamber 152 changes with time according to the change in inner volume by the inflow of the ink from the first pressure control chamber 122. Specifically, the pressure in the second pressure control chamber 152 changes according to Formula 2 until the communication port 191 shifts from the state of FIG. 10B to the closed state to allow no communication between the second valve chamber 151 and the second pressure control chamber 152 as illustrated in FIG. 10C. Thereafter, the pressing plate 210 dose not abut on the valve shaft 190a so that the communication port 191 shifts to the closed state. Then, as illustrated in FIG. 10D, the ink flows from the collection channel 140 into the second pressure control chamber 152. This inflow of the ink displaces the pressing plate 210 and the flexible member 230. The pressure in the second pressure control chamber 152 changes according to Formula 4. Specifically, the pressure increases until the inner volume of the second pressure control chamber 152 reaches the maximum.

Note that, once the state of FIG. 10C is reached, there is no more ink flow from the first pressure control chamber 122 into the second pressure control chamber 152 through the bypass channel 160 and the second valve chamber 151. Thus, the ink flow to the second pressure control chamber 152 through the collection channel 140 is only generated after the ink in the first pressure control chamber 122 is supplied to the ejection module 300 through the supply channel 130. As mentioned above, the ink moves from the first pressure control chamber 122 to the second pressure control chamber 152 according to the differential pressure between the pressure in the first pressure control chamber 122 and the pressure in the second pressure control chamber 152. Thus, in a case where the pressure in the second pressure control chamber 152 becomes equal to the pressure in the first pressure control chamber 122, the ink stops moving.

Also, in the state where the pressure in the second pressure control chamber 152 is equal to the pressure in the first pressure control chamber 122, the second pressure control chamber 152 expands to the state illustrated in FIG. 10D. In a case where the second pressure control chamber 152 expands as illustrated in FIG. 10D, a reservoir portion capable of holding the ink is formed in the second pressure control chamber 152. Note that the transition to the state of FIG. 10D after stopping the circulating pump 500 takes about 1 minute to 2 minutes. The time may vary depending on the shapes and sizes of the channels and properties of the ink. As the circulating pump 500 is driven in the state where the ink is held in the reservoir portion as illustrated in FIG. 1OD, the ink in the reservoir portion is supplied to the first pressure control chamber 122 by the circulating pump 500. Accordingly, as illustrated in FIG. 10E, the amount of the ink in the first pressure control chamber 122 increases so that the flexible member 230 and the pressing plate 210 are displaced in the expanding direction. Then, as the circulating pump 500 continues to be driven, the state inside the circulation path changes to the state illustrated in FIG. 10A.

Note that, in the above description, FIG. 10A has been described as an example of the ink circulation during a print operation. However, the ink may be circulated without a print operation, as mentioned above. Even in this case, the ink flows as illustrated in FIGS. 10A to 1OE in response to the driving and stopping of the circulating pump 500.

Also, as described above, in the present embodiment, an example has been used where the communication port 191B in the second pressure adjustment unit 150 shifts to the open state in a case where the ink is circulated by driving the circulating pump 500, and shifts to the closed state in a case where the ink circulation stops. However, the present embodiment is not limited to this example. The controlled pressure may be set such that the communication port 191B in the second pressure adjustment unit 150 is in the closed state even in a case where the ink is circulated by driving the circulating pump 500. This will be specifically described below along with the function of the bypass channel 160.

The bypass channel 160 connecting between the first pressure adjustment unit 120 and the second pressure adjustment unit 150 is provided in order that the ejection module 300 can avoid the effect of the strong negative pressure, for example, in a case where the negative pressure generated inside the circulation path becomes stronger than a preset value. The bypass channel 160 is also provided in order to supply the ink to the pressure chambers 12 from both the supply channel 130 and the collection channel 140.

First, description will be given of an example of avoiding the effect of the negative pressure becoming stronger than the preset value on the ejection module 300 by providing the bypass channel 160. For example, a change in environmental temperature sometimes changes a property (for example, viscosity) of the ink. As the viscosity of the ink changes, the pressure loss within the circulation path changes as well. For example, as the viscosity of the ink decreases, the amount of pressure loss within the circulation path decreases. As a result, the flow rate of the circulating pump 500 driven at a constant driving amount increases, and the flow rate through the ejection module 300 increases. Here, the ejection module 300 is kept at a constant temperature by a temperature adjustment mechanism (not illustrated). Hence, the viscosity of the ink inside the ejection module 300 is maintained constant even if the environmental temperature changes. The viscosity of the ink inside the ejection module 300 remains unchanged whereas the flow rate of the ink flowing through the ejection module 300 increases, and therefore the negative pressure in the ejection module 300 becomes accordingly stronger due to flow resistance. If the negative pressure in the ejection module 300 becomes stronger than the preset value as described above, there is a possibility that the menisci in the ejection ports 13 may break and the ambient air may be taken into the circulation path, which may lead to a failure to perform normal ejection. Also, even if the menisci do not break, there is still a possibility that the negative pressure in the pressure chambers 12 may become stronger than a predetermined level and affect the ejection.

For these reasons, in the present embodiment, the bypass channel 160 is formed in the circulation path. By providing the bypass channel 160, the ink flows through the bypass channel 160 in a case where the negative pressure is stronger than the preset value. Thus, the pressure in the ejection module 300 is kept constant. Thus, for example, the controlled pressure may be set such that the communication port 191B in the second pressure adjustment unit 150 is maintained in the closed state even in a case where the circulating pump 500 is driven. Moreover, the controlled pressure in the second pressure adjustment unit 150 may be set such that the communication port 191B in the second pressure adjustment unit 150 shifts to the open state in a case where the negative pressure becomes stronger than the preset value. In other words, the communication port 191B may be in the closed state in a case where the circulating pump 500 is driven as long as the menisci do not collapse or a predetermined negative pressure is maintained even if the flow rate of the pump changes due to the change in viscosity caused by an environmental change or the like.

Next, description will be given of an example where the bypass channel 160 is provided in order to supply the ink to the pressure chambers 12 from both the supply channel 130 and the collection channel 140. The pressure in the circulation path may fluctuate due to the ejection operations of the ejection elements 15. This is because the ejection operations generate a force that draws the ink into the pressure chambers.

In the following, description will be given of the facts that the ink to be supplied to the pressure chambers 12 is supplied from both the supply channel 130 side and the collection channel 140 side, in a case of continuing high-duty printing. While the definition of “duty” may vary depending on various conditions, in the following, a state where a 1200 dpi grid cell is printed with a single 4 pl ink droplet will be considered 100%. “High-duty printing” is, for example, printing performed at a duty of 100%.

In a case of continuing high-duty printing, the amount of the ink flowing from the pressure chambers 12 into the second pressure control chamber 152 through the collection channel 140 decreases. On the other hand, the circulating pump 500 causes the ink to flow out in a constant amount. This breaks the balance between the inflow into and the outflow from the second pressure control chamber 152. Consequently, the ink inside the second pressure control chamber 152 decreases and the negative pressure in the second pressure control chamber 152 becomes stronger so that the second pressure control chamber 152 shrinks. As the negative pressure in the second pressure control chamber 152 becomes stronger, the amount of inflow of the ink into the second pressure control chamber 152 through the bypass channel 160 increases, and the second pressure control chamber 152 becomes stable in the state where the outflow and the inflow are balanced. Thus, the negative pressure in the second pressure control chamber 152 becomes stronger according to the duty. Also, as mentioned above, under the configuration in which the communication port 191B is in the closed state in a case where the circulating pump 500 is driven, the communication port 191B shifts to the open state depending on the duty so that the ink flows from the bypass channel 160 into the second pressure control chamber 152.

Moreover, as high-duty printing is continued further, the amount of inflow into the second pressure control chamber 152 from the pressure chambers 12 through the collection channel 140 decreases and conversely the amount of inflow into the second pressure control chamber 152 from the communication port 191B through the bypass channel 160 increases. As this state progresses further, the amount of the ink flowing into the second pressure control chamber 152 from the pressure chambers 12 through the collection channel 140 reaches zero so that the ink flowing from the communication port 191B is the entire ink flowing out into the circulating pump 500. As this state progresses further, the ink backs up from the second pressure control chamber 152 into the pressure chambers 12 through the collection channel 140. In this state, the ink flowing from the second pressure control chamber 152 into the circulating pump 500 and the ink flowing from the second pressure control chamber 152 into the pressure chambers 12 will flow from the communication port 191B into the second pressure control chamber 152 through the bypass channel 160. In this case, the ink from the supply channel 130 and the ink from the collection channel 140 are filled into the pressure chambers 12 and ejected therefrom.

Note that this ink backflow that occurs in a case where the printing duty is high is a phenomenon that occurs due to the installation of the bypass channel 160. Also, as described above, an example has been described in which the communication port 191B in the second pressure adjustment unit shifts to the open state for the backflow of the ink. However, the backflow of the ink may also occur in the state where the communication port 191B in the second pressure adjustment unit is in the open state. Moreover, in a configuration without the second pressure adjustment unit, the above backflow of the ink can also occur by installing the bypass channel 160.

### Configuration of Ejection Unit

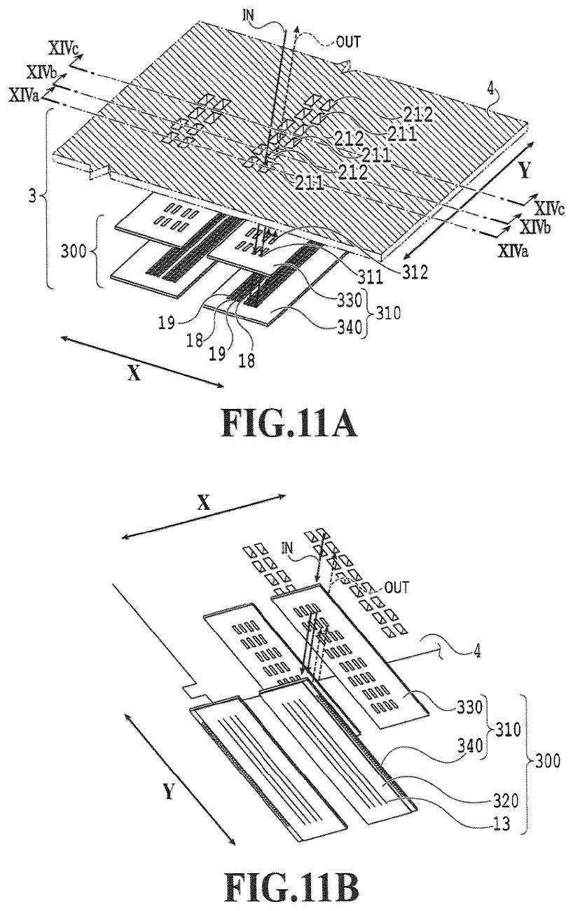

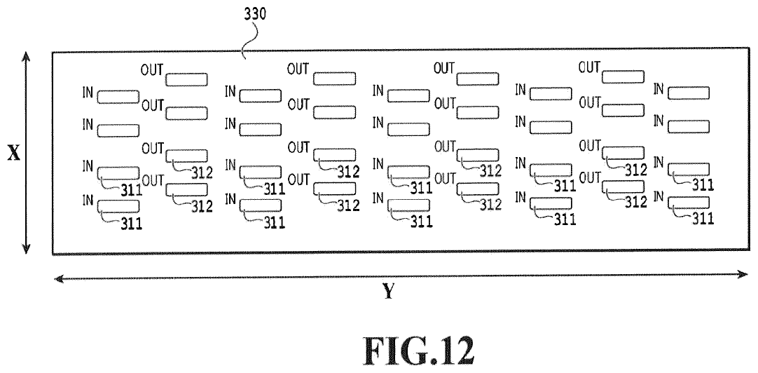

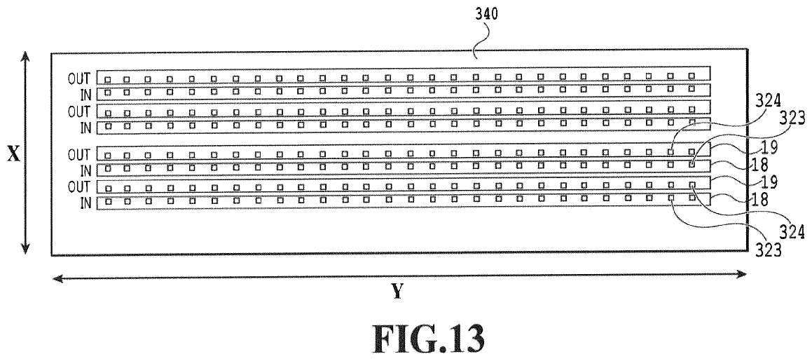

FIGS. 11A and 11B are schematic views illustrating a circulation path for an ink of one color in the ejection unit 3 in the present embodiment. FIG. 11A is an exploded perspective view of the ejection unit 3 as seen from the first support member 4 side. FIG. 11B is an exploded perspective view of the ejection unit 3 as seen from the ejection module 300 side. Note that the arrows denoted as “IN” and “OUT” in FIGS. 11A and 11B indicate the ink flow, and the ink flow will be described only for one color, but the inks of the other colors flow similarly. Moreover, in FIGS. 11A and 11B, illustration of the second support member 7 and the electric wiring member 5 is omitted, and description thereof is also omitted in the following description of the configuration of the ejection unit. Moreover, as for the first support member 4 in FIG. 11A, a cross section along the line XI-XI in FIG. 3A is illustrated. Each ejection module 300 includes an ejection element substrate 340 and an opening plate 330. FIG. 12 is a view illustrating the opening plate 330. FIG. 13 is a view illustrating the ejection element substrate 340.

The ejection unit 3 is supplied with an ink from each circulation unit 54 through the joint member 8 (see FIG. 3A). An ink path for an ink to return to the joint member 8 after passing the joint member 8 will now be described. Note that illustration of the joint member 8 is omitted in drawings to be mentioned below.

Each ejection module 300 includes the ejection element substrate 340 and the opening plate 330, which are the silicon substrate 310, and further includes the ejection port forming member 320. The ejection element substrate 340, the opening plate 330, and the ejection port forming member 320 form the ejection module 300 by being stacked and joined such that channels of respective inks communicate with each other. The ejection module 300 is supported on the first support member 4. The ejection unit 3 is formed by supporting each ejection module 300 on the first support member 4. The ejection element substrate 340 includes the ejection port forming member 320, and the ejection port forming member 320 includes a plurality of ejection port arrays each being a plurality of ejection ports 13 forming a line. Part of the ink supplied through ink channels in the ejection module 300 is ejected from the ejection ports 13. The ink not ejected is collected through ink channels in the ejection module 300.

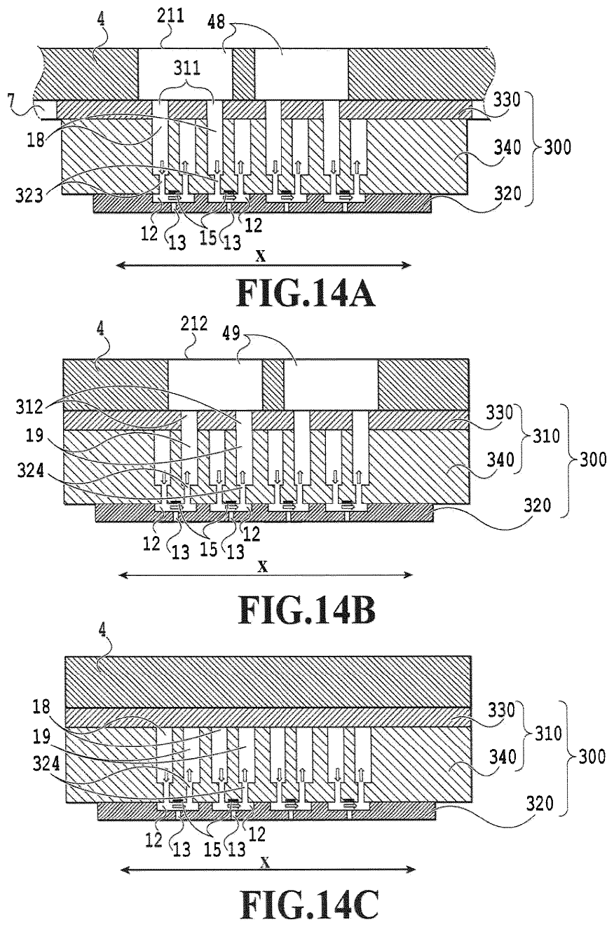

As illustrated in FIGS. 11A and 11B and FIG. 12, the opening plate 330 includes a plurality of arrayed ink supply ports 311 and a plurality of arrayed ink collection ports 312. As illustrated in FIG. 13 and FIGS. 14A to 14C, the ejection element substrate 340 includes a plurality of arrayed supply connection channels 323 and a plurality of arrayed collection connection channels 324. The ejection element substrate 340 further includes the common supply channels 18 communicating with the plurality of supply connection channels 323 and the common collection channels 19 communicating with the plurality of collection connection channels 324. The ink supply channels 48 and the ink collection channels 49 (see FIG. 3A) disposed in the first support member 4 and the channels disposed in each ejection module 300 communicate with each other to form the ink channels inside the ejection unit 3. Support member supply ports 211 are openings in cross section forming the ink supply channels 48. Support member collection ports 212 are openings in cross section forming the ink collection channels 49.

The ink to be supplied to the ejection unit 3 is supplied from the circulation unit 54 (see FIG. 3A) side to the ink supply channels 48 (see FIG. 3A) in the first support member 4. The ink flowed through the support member supply ports 211 in the ink supply channels 48 is supplied to the common supply channels 18 in the ejection element substrate 340 through the ink supply channels 48 (see FIG. 3A) and the ink supply ports 311 in the opening plate 330, and enters the supply connection channels 323. The channels up to this point are the supply-side channels. Thereafter, the ink passes through the pressure chambers 12 (see FIG. 3B) in the ejection port forming member 320 and flows into the collection connection channels 324 of the collection-side channels. Details of the ink flow in the pressure chambers 12 will be described below.

In the collection-side channels, the ink having entered the collection connection channels 324 flows into the common collection channels 19. Thereafter, the ink flows from the common collection channels 19 into the ink collection channels 49 in the first support member 4 through the ink collection ports 312 in the opening plate 330, and is collected into the circulation unit 54 through the support member collection ports 212.

Regions of the opening plate 330 where the ink supply ports 311 or the ink collection ports 312 are not present correspond to regions of the first support member 4 for separating the support member supply ports 211 and the support member collection ports 212. Also, the first support member 4 does not have openings at these regions. Such regions are used as bonding regions in a case of bonding the ejection module 300 and the first support member 4.

In FIG. 12, a plurality of arrays of openings arranged along the X direction are provided side by side in the Y direction in the opening plate 330, and the openings for supply (IN) and the openings for collection (OUT) are arranged alternately in the Y direction while being shifted from each other by a half pitch in the X direction. In FIG. 13, in the ejection element substrate 340, the common supply channels 18 communicating with the plurality of supply connection channels 323 arrayed in the Y direction and the common collection channels 19 communicating with the plurality of collection connection channels 324 arrayed in the Y direction are arrayed alternately in the X direction. The common supply channels 18 and the common collection channels 19 are separated by the ink type. Moreover, the number of ejection port arrays for each color determines the numbers of common supply channels 18 and common collection channels 19 to be disposed. Also, the number of the disposed supply connection channels 323 and the number of the disposed collection connection channels 324 corresponds to the number of ejection ports 13. Note that a one-to-one correspondence is not necessarily essential, and a single supply connection channel 323 and a single collection connection channel 324 may correspond to a plurality of ejection ports 13.

Each ejection module 300 is formed by stacking and joining the opening plate 330 and the ejection element substrate 340 as above such that channels of respective inks communicate with each other, and is supported on the first support member 4. As a result, ink channels including the supply channels and the collection channels as above are formed.

FIGS. 14A to 14C are cross-sectional views illustrating ink flows at different portions of the ejection unit 3. FIG. 14A is a cross section taken along the line XIVa-XIVa in FIG. 11A, and illustrates a cross section of a portion of the ejection unit 3 where ink supply channels 48 and ink supply ports 311 communicate with each other. FIG. 14B is a cross section taken along the line XIVb-XIVb in FIG. 11A, and illustrates a cross section of a portion of the ejection unit 3 where ink collection channels 49 and ink collection ports 312 communicate with each other. Also, FIG. 14C is a cross section taken along the line XIVc-XIVc in FIG. 11A, and illustrates a cross section of a portion where the ink supply ports 311 and the ink collection ports 312 do not communicate with channels in the first support member 4. Note that the liquid sending element 1001 is omitted in FIGS. 14A to 14C.

As illustrated in FIG. 14A, the supply channels for supplying the inks supply the inks from the portions where the ink supply channels 48 in the first support member 4 and the ink supply ports 311 in the opening plate 330 overlap and communicate with each other. Moreover, as illustrated in FIG. 14B, the collection channels for collecting the inks collect the inks from the portions where the ink collection channels 49 in the first support member 4 and the ink collection ports 312 in the opening plate 330 overlap and communicate with each other. Furthermore, as illustrated in FIG. 14C, the ejection unit 3 locally has regions where no opening is provided in the opening plate 330. At such regions, the inks are neither supplied nor collected between the ejection element substrate 340 and the first support member 4. The inks are supplied at the regions where the ink supply ports 311 are provided, as illustrated in FIG. 14A. The inks are collected at regions where the ink collection ports 312 are provided, as illustrated in FIG. 14B. Note that the present embodiment has been described by taking the configuration using the opening plate 330 as an example, but a configuration not using the opening plate 330 may be employed. For example, the configuration may be employed in which channels corresponding to the ink supply channels 48 and the ink collection channels 49 are formed in the first support member 4, and the ejection element substrate 340 is joined to the first support member 4.

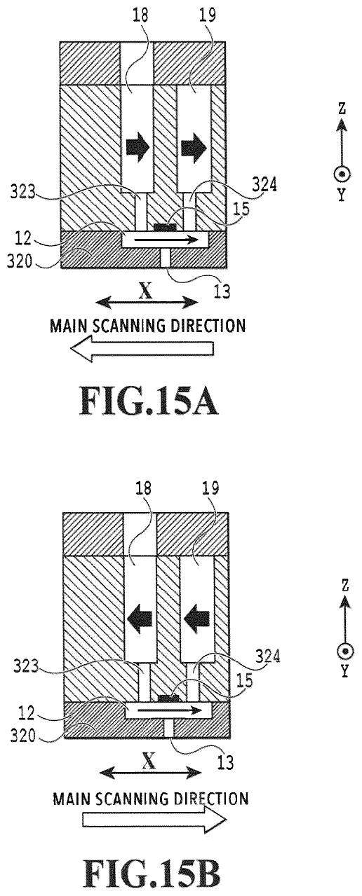

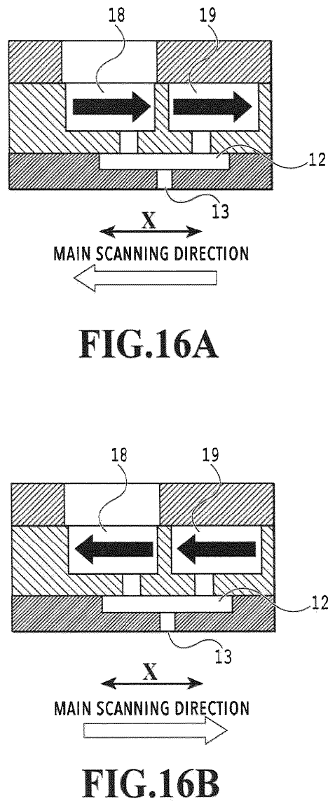

FIGS. 15A and 15B are cross-sectional views illustrating the vicinity of an ejection port 13 in an ejection module 300. FIGS. 16A and 16B are cross-sectional views illustrating an ejection module having a configuration as a comparative example in which the common supply channel 18 and the common collection channel 19 are widened in the X direction. Note that the bold arrows illustrated in the common supply channel 18 and the common collection channel 19 in FIGS. 15A and 15B and FIGS. 16A and 16B indicate the oscillating movement of an ink which occurs in the configuration using the serial liquid ejection apparatus 50. The ink supplied to the pressure chamber 12 through the common supply channel 18 and the supply connection channel 323 is ejected from the ejection port 13 as the ejection element 15 is driven. In a case where the ejection element 15 is not driven, the ink is collected from the pressure chamber 12 into the common collection channel 19 through the collection connection channel 324, which is a collection channel.

In a case of ejecting the ink circulated as above in the configuration using the serial liquid ejection apparatus 50, the ink ejection is affected to no small extent by the oscillating movement of the ink inside the ink channels caused by the main scanning of the liquid ejection head 1. Specifically, the influence of the oscillating movement of the ink inside the ink channels appears as a difference in the amount of the ink ejected and a deviation in ejection direction. As illustrated in FIGS. 16A and 16B, in a case where the common supply channel 18 and the common collection channel 19 have cross-sectional shapes which are wide in the X direction, which is the main scanning direction, the inks inside the common supply channel 18 and the common collection channel 19 more easily receive inertial forces in the main scanning direction so that the inks oscillate greatly. This leads to a possibility that the oscillating movements of the inks may affect the ejection of the inks from the ejection ports 13. Moreover, widening the common supply channel 18 and the common collection channel 19 in the X direction widens the distance between the colors. This may lower the printing efficiency.

Hence, each common supply channel 18 and each common collection channel 19 in the present embodiment whose cross sections are illustrated in FIGS. 15A and 15B have a configuration that, each common supply channel 18 and each common collection channel 19 extend in the Y direction and also extend in the Z direction, which is perpendicular to the X direction as the main scanning direction. With such a configuration, the common supply channel 18 and the common collection channel 19 can be given small channel widths in the main scanning direction. By giving the common supply channel 18 and the common collection channel 19 small channel widths in the main scanning direction, the oscillating movement of the ink inside the common supply channel 18 and the common collection channel 19 by the inertial force acting on the ink and exerted in the direction opposite to the main scanning direction (the black bold arrows in FIGS. 15A and 15B) during main scanning becomes smaller. This reduces the influence of the oscillating movement of the ink in the ejection of the ink. Moreover, by extending the common supply channel 18 and the common collection channel 19 in the Z direction, their cross-sectional areas are increased. This reduces the channel pressure drop.

As described above, each common supply channel 18 and each common collection channel 19 are given small channel widths in the main scanning direction. This configuration reduces the oscillating movement of the ink inside the common supply channel 18 and the common collection channel 19 during main scanning but does not eliminate the oscillating movement. Thus, in the present embodiment, in order to reduce the difference in ejection between the ink types that may be generated by the reduced oscillating movement, the configuration is such that the common supply channel 18 and the common collection channel 19 are disposed at positions overlapping each other in the X direction.

As described above, in the present embodiment, the supply connection channels 323 and the collection connection channels 324 are provided so as to correspond to the ejection ports 13. Moreover, the correspondence relationship between the supply connection channels 323 and the collection connection channels 324 establishes such that the supply connection channels 323 and the collection connection channels 324 are arrayed in the X direction with the ejection ports 13 interposed therebetween. Thus, if the common supply channel 18 and the common collection channel 19 have a portion where the common supply channel 18 and the common collection channel 19 do not overlap each other in the X direction, the correspondence between the supply connection channels 323 and the collection connection channels 324 in the X direction breaks. This incorrespondence affects the ink flow in the pressure chambers 12 in the X direction and the ink ejection. If this incorrespondence is combined with the influence of the oscillating movement of the ink, there is a possibility that it may further affect the ink ejection from each ejection port.

Thus, by disposing the common supply channel 18 and the common collection channel 19 at positions overlapping each other in the X direction, the oscillating movement of the ink inside the common supply channel 18 and the common collection channel 19 during main scanning is substantially the same at any position in the Y direction, in which the ejection ports 13 are arrayed. Thus, the pressure differences generated in the pressure chambers 12 between the common supply channel 18 side and the common collection channel 19 side do not greatly vary. This enables stable ejection.

Also, some liquid ejection heads which circulate an ink therein are configured such that the channel for supplying the ink to the liquid ejection head and the channel for collecting the ink are the same channel. However, in the present embodiment, the common supply channel 18 and the common collection channel 19 are different channels. Moreover, the supply connection channels 323 and the pressure chambers 12 communicate with each other, the pressure chambers 12 and the collection connection channels 324 communicate with each other, and the inks are ejected from the ejection ports 13 in the pressure chambers 12. That is, the configuration is formed in which the pressure chambers 12 serving as paths connecting the supply connection channels 323 and the collection connection channels 324 include the ejection ports 13. Hence, in each pressure chamber 12, an ink flow flowing from the supply connection channel 323 side to the collection connection channel 324 side is generated, and the ink inside the pressure chamber 12 is efficiently circulated. The ink inside the pressure chamber 12, which tends to be affected by evaporation of the ink from the ejection port 13, is kept fresh by efficiently circulating the ink inside the pressure chamber 12.

Also, since the two channels, namely the common supply channel 18 and the common collection channel 19, communicate with the pressure chamber 12, the ink can be supplied from both channels in a case where it is necessary to perform ejection with a high flow rate. That is, compared to the configuration in which only a single channel is formed for ink supply and collection, the configuration in the present embodiment has an advantage that not only efficient circulation can be performed but also ejection at a high flow rate can be handled.

Incidentally, the oscillating movement of the ink causes a less effect in a case where the common supply channel 18 and the common collection channel 19 are disposed at positions close to each other in the X direction. The common supply channel 18 and the common collection channel 19 are desirably disposed such that the gap between the channels is 75 μm to 100 μm.

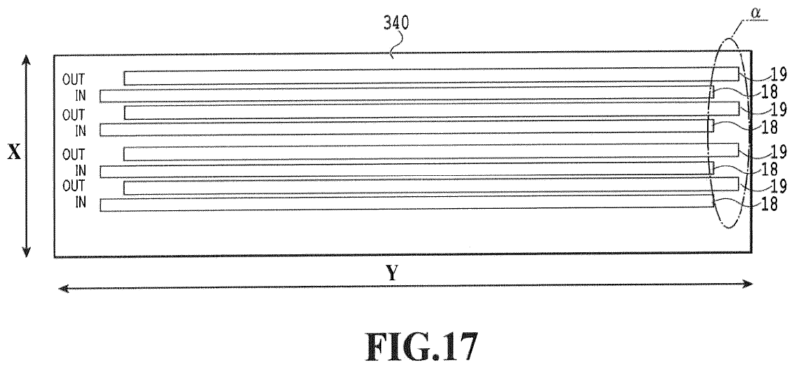

FIG. 17 is a view illustrating an ejection element substrate 340 as a comparative example. Note that illustration of the supply connection channels 323 and the collection connection channels 324 is omitted in FIG. 17. The inks having received thermal energy from the ejection elements 15 in the pressure chambers 12 flow into the common collection channels 19. Hence, the temperature of the inks flowing through the common collection channels 19 is higher than the temperature of the inks in the common supply channels 18. Here, in the comparative example, only the common collection channels 19 are present at one portion of the ejection element substrate 340 in the X direction, as indicated by a portion a circled with the dash-dotted line in FIG. 17. In this case, the temperature may locally rise at that portion, thereby causing temperature unevenness within the ejection module 300. This temperature unevenness may affect the ejection.

The temperature of the inks flowing through the common supply channels 18 is lower than that in the common collection channels 19. Thus, if the common supply channels 18 and the common collection channels 19 are close to each other, the ink in the common supply channels 18 whose temperature is relatively lower lowers the temperature of the ink in the common collection channels 19 at the points where both channels are close. This suppresses a temperature rise. For this reason, it is preferable that the common supply channels 18 and the common collection channels 19 have substantially the same length, be present at positions overlapping each other in the X direction, and be close to each other.

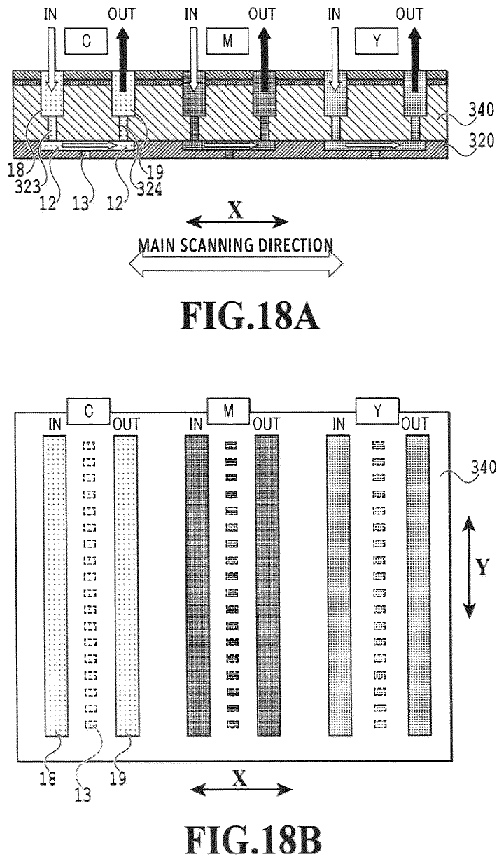

FIGS. 18A and 18B are views illustrating a channel configuration of the liquid ejection head 1 for the inks of the three colors of cyan (C), magenta (M), and yellow (Y). In the liquid ejection head 1, a circulation channel is provided for each ink type as illustrated in FIG. 18A. The pressure chambers 12 are provided along the X direction, which is the main scanning direction of the liquid ejection head 1. Also, as illustrated in FIG. 18B, the common supply channels 18 and the common collection channels 19 are provided along the ejection port arrays, which are arrays of ejection ports 13. The common supply channels 18 and the common collection channels 19 are provided so as to extend in the Y direction with the ejection port arrays therebetween.

### Connection of Main Body Units and Liquid Ejection Head

FIG. 19 is a schematic configuration diagram more specifically illustrating a state where an ink tank 2 and an external pump 21 provided as main body units of the liquid ejection apparatus 50 in the present embodiment and the liquid ejection head 1 are connected, and an arrangement of a circulating pump 500 and the like. The liquid ejection apparatus 50 in the present embodiment has such a configuration that only the liquid ejection head 1 can be easily replaced in a case where a trouble occurs in the liquid ejection head 1. Specifically, the liquid ejection apparatus 50 in the present embodiment has liquid connection parts 700 in which the respective ink supply tubes 59 connected to the respective external pumps 21, and the liquid ejection head 1 can be easily connected to and disconnected from each other. This enables only the liquid ejection head 1 to be easily attached to and detached from the liquid ejection apparatus 50.

As illustrated in FIG. 19, each liquid connection part 700 has a liquid connector insertion slot 53a which is provided in a protruding manner on the head housing 53 of the liquid ejection head 1, and a cylindrical liquid connector 59a into which this liquid connector insertion slot 53a can be inserted. The liquid connector insertion slot 53a is fluidly connected to the ink supply channel formed in the liquid ejection head 1, and is connected to the first pressure adjustment unit 120 through the filter 110 mentioned above. The liquid connector 59a is disposed at the tip of the ink supply tube 59 connected to the external pump 21 which supplies the ink in the ink tank 2 to the liquid ejection head 1 by pressurization.

As described above, the liquid ejection head 1 illustrated in FIG. 19 has the liquid connection part 700, which facilitates the work of attaching, detaching, and replacing the liquid ejection head 1. However, in a case where the sealing performance between the liquid connector insertion slot 53a and the liquid connector 59a deteriorates, there is a possibility that the ink supplied by pressurization by the external pump 21 may leak from the liquid connection part 700. The leaked ink may cause trouble in the electrical system if attached to the circulating pump 500 or the like. To address this, in the present embodiment, the circulating pump and the like are disposed as below.

### Arrangement of Circulating Pump and the Like

In the present embodiment, as illustrated in FIG. 19, in order to avoid attachment of the ink leaking from the liquid connection part 700 to the circulating pump 500, the circulating pump 500 is disposed higher than the liquid connection part 700 in the direction of gravity. Specifically, the circulating pump 500 is disposed higher than the liquid connector insertion slot 53a, which is a liquid inlet in the liquid ejection head 1, in the direction of gravity. Moreover, the circulating pump 500 is disposed at such a position as to be out of contact with the constituent members of the liquid connection part 700. In this way, even if the ink leaks from the liquid connection part 700, the ink flows in a horizontal direction which is the opening direction of the liquid connector 59a or downward in the direction of gravity. This prevents the ink from reaching the circulating pump 500 located higher in the direction of gravity. Moreover, disposing the circulating pump 500 at a position separated from the liquid connection part 700 also reduces the possibility of the ink reaching the circulating pump 500 through members.

Furthermore, an electric connection part 515 electrically connecting the circulating pump 500 and the electric contact substrate 6 through a flexible wiring member 514 is provided higher than the liquid connection part 700 in the direction of gravity. Thus, the concern of an electrical trouble caused by the ink leaked from the liquid connection part 700 can be reduced.

In addition, in the present embodiment, a wall portion 53b of the head housing 53 is provided. Thus, even if the ink jets out from the opening 59b of the liquid connection part 700, the wall portion 53b blocks the ink and thus reduces the concern of the ink reaching the circulating pump 500 or the electric connection part 515.

The features of the present disclosure will be described below.

### First Embodiment

### Circulation Channel in Ejection Module

The features of the present disclosure will be described below. FIG. 20A is a partially enlarged view of the ejection module 300 according to the present embodiment, and is a schematic view as seen along the ejection direction. FIG. 20B is a schematic cross-sectional view of the ejection module 300 according to the present embodiment. The ejection module 300 of the present embodiment has a configuration in which a nozzle plate 1006 to form the ejection ports 13, an individual channel layer 1007 to mainly form individual channels, a first substrate 1008, and a second substrate 1009 are laminated in this order in the Z direction. The structure of the ejection module 300 and the flow of the ink in the circulation channel will be described below. Note that the arrows in FIGS. 20A and 20B indicate the flow direction of the ink.

The nozzle plate 1006 has a plurality of ejection ports 13 formed therein to eject the ink. The individual channel layer 1007 is provided with a plurality of individual channels 1002, a plurality of pressure chambers 12, and a plurality of filters 1003 provided on the ink supply side and the ink collection side. The first substrate 1008 to serve as an element substrate is provided with ejection elements 15 for ejecting the ink, liquid sending elements 1001 for circulating the ink, a temperature adjustment mechanism 1016 for warming the ink before ejection, supply connection channels 323, and collection connection channels 324. In the second substrate 1009 to serve as a common channel substrate, common supply channels 18 communicating with the supply connection channels 323 and common collection channels 19 communicating with the collection connection channels 324 are formed. The temperature adjustment mechanism 1016 is a mechanism for adjusting the ink in the individual channels 1002 to an adequate temperature (viscosity).

The plurality of individual channels 1002 are channels formed by the nozzle plate 1006, the individual channel layer 1007, and the first substrate 1008, and are formed so as to extend in the X direction. The individual channels 1002 include individual supply channels 1004 on the ink supply side and individual collection channels 1005 on the ink collection side. The individual supply channels 1004 communicate with the supply connection channel 323. The individual collection channels 1005 communicate with the collection connection channel 324. This allows the individual channels 1002 to function as paths through which the ink can be supplied and circulated.

The pressure chamber 12 is a region for generating energy for ejecting a liquid, and does not need to be a clearly defined chamber. The ejection element 15 is provided inside the pressure chamber 12.

The filter 1003 is provided between the supply connection channel 323 and the individual supply channel 1004. The filter 1003 is also provided between the individual collection channel 1005 and the collection connection channel 324. This makes it possible to prevent foreign substances, bubbles, and the like from entering the individual channels 1002.

The ejection elements 15 are provided in the individual channels 1002 at positions facing the ejection ports 13. The ejection elements 15 generate ejection energy to eject the ink from the ejection ports 13. As described above, the electrothermal conversion element (heater) is used as the ejection element 15 in the present embodiment, but a piezoelectric actuator (piezo element) may also be used.

The liquid sending elements 1001 are each disposed on the individual supply channel 1004 side at a predetermined distance from the ejection element 15 in the X direction. The liquid sending elements 1001 generate thermal energy to circulate the ink in the individual channels 1002. As the liquid sending elements 1001 are driven, the ink is heated and sent out by film boiling of the ink. An electrothermal conversion element (heater) is used as the liquid sending element 1001 in the present embodiment, but a piezoelectric actuator (piezo element) may also be used. In the present disclosure, the circulation of the ink sent by the liquid sending element 1001 is called microcirculation 1011. This allows the ink in the individual channels 1002 to be sent from the individual supply channels 1004 to the individual collection channels 1005 via the pressure chambers 12. The liquid sending element 1001 may send the liquid in a state where the liquid ejection apparatus 50 is stopped.

The ink supplied from the circulation unit 54 passes through the common supply channel 18 and flows into the individual channel 1002 and the pressure chamber 12 via the supply connection channel 323. The ink having flowed into the pressure chamber 12 flows out of the common collection channel 19 through the collection connection channel 324. At this time, the circulation of the ink sent into the ejection module 300 by the circulation unit 54 is called macrocirculation 1012 in the present disclosure.

Here, the flow resistance between the liquid sending element 1001 and the individual supply channel 1004 is RI, and the flow resistance between the liquid sending element 1001 and the individual collection channel 1005 is R2. Since the liquid sending element 1001 is located closer to the individual supply channel 1004 than the individual collection channel 1005, the flow resistance RI is smaller than the flow resistance R2. For this reason, bubbles generated by driving the liquid sending element 1001 tend to grow on the individual supply channel 1004 side. As the bubbles shrink, the ink flows in to compensate for the volume. Hence, more ink flows from the individual supply channel 1004 than from the individual collection channel 1005. As a result, the ink flows from the individual supply channel 1004 to the individual collection channel 1005. That is, the microcirculation 1011 is generated. The ratio of the flow resistance R1 to the flow resistance R2 affects the left-right ratio of the bubbles, which in tum affects the size of the microcirculation flow. In the present embodiment, the flow resistance ratio R1/R2 is preferably set in the range of 0.05 to 0.4. By setting the flow resistance ratio R1/R2 in this range, the circulation flow within the individual channel 1002 can be kept within a suitable range.

As described above, in the present embodiment, in the circulation unit 54, a piezoelectric diaphragm pump is used as the circulating pump 500 capable of sending the liquid. The piezoelectric diaphragm pump can be driven on demand only when circulation is required. The timing for driving the piezoelectric diaphragm pump is preferably immediately before driving the ejection element 15 and the liquid sending element 1001, or after stopping the ejection element 15 and the liquid sending element 1001 for a long period of time.

In this way, in the configuration of the present embodiment, as the ink is consumed, new ink can be supplied into the individual channels 1002. Also, even in a case where the ink is not consumed, new ink can be circulated in the individual channels 1002.

### Driving Signal for Liquid Sending Element

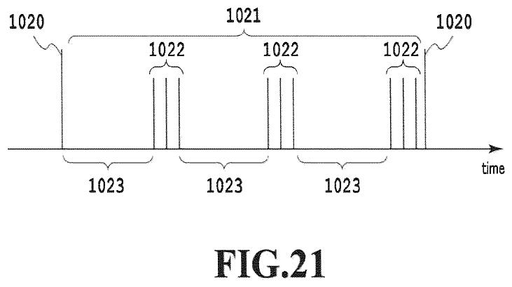

FIG. 21 is a diagram illustrating an ejection pulse for driving an ejection element and a driving pulse for a liquid sending element. As the head driver 1A (see FIG. 1B) applies an ejection pulse 1020 to the ejection element 15, the ink is ejected from the ejection port 13, and an ejection pulse pause time 1021 occurs until the next ejection pulse 1020 is applied to the ejection element 15. If the head driver 1A applies a liquid sending element driving pulse 1022 to the liquid sending element 1001 during the ejection pulse pause time 1021, the liquid sending element 1001 is driven to generate the microcirculation 1011 in the individual channel 1002. In the present embodiment, a liquid sending element driving pulse pause time 1023 is provided between the ejection pulse 1020 and the liquid sending element driving pulse 1022 and between the liquid sending element driving pulse 1022 and the next liquid sending element driving pulse 1022. The liquid sending element driving pulse 1022 is applied to the liquid sending element 1001 after the liquid sending element driving pulse pause time 1023 has elapsed. In the present embodiment, the liquid sending element driving pulse pause time 1023 and the liquid sending element driving pulse 1022 are repeated three times during the ejection pulse pause time 1021. In this way, by intermittently applying the liquid sending element driving pulses 1022, the liquid in the individual channel 1002 is intermittently sent. Thereafter, the head driver 1A (see FIG. 1B) applies the ejection pulse 1020 to the ejection element 15, and the ink is ejected from the ejection ports 13. Note that, in the present embodiment, the liquid sending element driving pulse pause time 1023 and the liquid sending element driving pulse 1022 are repeated three times during the ejection pulse pause time 1021. However, the present embodiment is not limited to this example. It is preferable that the liquid sending element driving pulse 1022 is applied to the liquid sending element 1001 at least once before the ejection pulse 1020 is applied to the ejection element 15.

### Control of Circulation Unit

Referring again to FIG. 6, the macrocirculation 1012 in the present embodiment is implemented by driving the circulating pump 500 to circulate the ink between the ejection module 300 and the circulation unit 54. At this time, the circulating pump 500 is driven on demand based on the condition determination by the CPU 103 (see FIG. 1B). In the present disclosure, “driven on demand” means that the circulating pump is not driven steadily during a print operation or non-print operation, and the CPU determines whether to drive the circulating pump based on a condition other than the presence or absence of a print operation.

For example, the circulating pump 500 may be started immediately before the print operation and stopped after a predetermined period of time has elapsed since the print operation is finished. In addition, if the liquid ejection apparatus is not used for a long period of time, the circulating pump 500 may be driven periodically to reduce deposition of precipitated components. Furthermore, a sensor for detecting a dispersion state of a color material may be provided in the circulation channel for each color, and the circulating pump 500 may be driven as the concentration of the color material exceeds a predetermined value.

Even during the print operation, the circulating pump 500 may be temporarily stopped or the driving cycle may be changed to reduce excessive flows in the individual channels 1002. For example, in the liquid ejection head 1 of the present embodiment, so-called temperature adjustment control is performed to adjust the temperature (viscosity) of the ink, using the temperature adjustment mechanism 1016, in order to achieve appropriate ejection. In cases where the macrocirculation flow causes the ink in the individual channels 1002 to flow more than necessary and reduces the effect of the temperature adjustment control, it is preferable that the circulating pump 500 be temporarily stopped or the driving cycle be changed. The above control is performed by the CPU 103 according to a program stored in the ROM 101 (see FIG. 1B).

In this way, according to the present embodiment, the circulation unit 54 and the liquid sending element 1001 are driven independently of each other at the required timing. This allows the microcirculation 1011 to be generated in the individual channel 1002, while allowing circulation at a high flow velocity only at the required timing between the ejection module 300 and the circulation unit 54. This makes it possible to appropriately suppress the ink concentration and precipitation in the entire liquid ejection head while suppressing the evaporation speed of the ink evaporating from the ejection ports 13. In addition, power consumption can be reduced by driving the circulating pump 500 at the required timing.

Note that, in a configuration in which macrocirculation is always generated as in Document 1, even if the temperature of the ink in the pressure chamber is adjusted, cold ink flows into the pressure chamber by circulation. This causes large exhaust heat. Therefore, there is a problem of too much power being consumed by the temperature adjustment. Also, since the temperature adjustment takes time, the start-up of the apparatus until the ejection operation can be started is delayed. In addition, in the configuration of Document 1, evaporation from the ejection ports always progresses, leading to a problem that the concentration in the entire supply system progresses. Furthermore, there is a problem of increased power consumption in the main body because the circulating pump is always driven. To address such problems, it is desirable to drive the macrocirculation intermittently at the required timing, as in the configuration of the present embodiment.

In the present embodiment, in addition to the microcirculation using the liquid sending element 1001, the macrocirculation is performed to circulate the ink inside the head using the circulation unit 54, thereby eliminating the ink concentration inside the pressure chamber 12. Highly responsive macrocirculation is achieved by using a piezoelectric circulating pump 500 and adopting a configuration in which the circulation path has a short path length that is completed inside the liquid ejection head. This makes it possible to drive the circulating pump 500 on demand, and to suppress exhaust heat inside the pressure chamber and evaporation from the ejection ports.

The effects of driving the microcirculation and macrocirculation will be described below in three parts. In a case where the microcirculation is stopped and only the macrocirculation is operated, it is possible to eliminate the ink concentration and precipitation in the entire supply system while suppressing the evaporation from the ejection ports 13. In a case where the microcirculation is operated and the macrocirculation is stopped, it is possible to perform the circulation only inside the pressure chambers 12. Therefore, by driving the liquid sending elements 1001 immediately before the ejection operation, it is possible to replace the ink inside the channels with fresh ink and suppress a decrease in ejection efficiency. In a case where both the microcirculation and macrocirculation are operated, both circulation systems are temporarily driven if the ink is significantly concentrated or precipitated in both the supply system and the ejection ports, such as immediately after a long pause in the ejection operation. This makes it possible to circulate the ink through the ink channels in the entire head while suppressing exhaust heat. In this case, the microcirculation allows the thickened ink on the ejection elements 15 or the liquid sending elements 1001 to flow immediately before ejection. Therefore, it is possible to suppress a decrease in foaming efficiency caused by the thickened ink on the ejection elements 15 or the liquid sending elements 1001.

### Second Embodiment

A circulation configuration in a second embodiment of the present disclosure will be described. Only differences from the circulation configuration in the first embodiment will be described.

### Circulation Path in Ejection Module

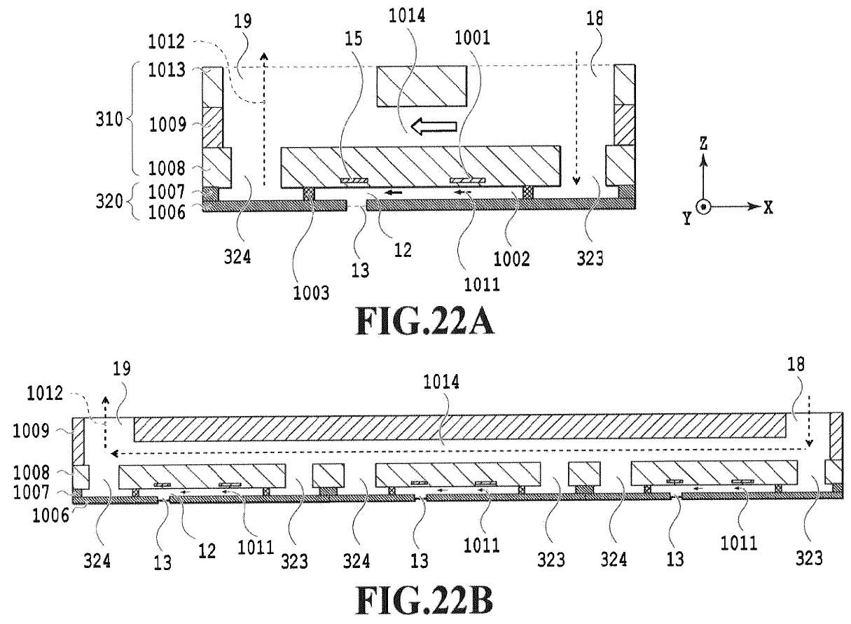

FIG. 22A is a schematic cross-sectional view of an ejection module 300 of the present embodiment. The ejection module 300 of the present embodiment has a configuration in which a nozzle plate 1006 to form ejection ports 13, an individual channel layer 1007 to mainly form individual channels, a first substrate 1008, a second substrate 1009, and a third substrate 1013 are laminated in this order in the Z direction. The structure of the ejection module 300 and the flow of the ink in the circulation channel will be described below. Note that the arrows in FIG. 22A indicate the flow direction of the ink.

In the first substrate 1008, ejection elements 15 for ejecting the ink, liquid sending elements 1001 for circulating the ink, supply connection channels 323, and collection connection channels 324 are formed. In the second substrate 1009, connection channels 1014 are formed, which communicate with both the plurality of supply connection channels 323 and the plurality of collection connection channels 324, and directly connect the common supply channels 18 and the common collection channels 19. In the third substrate 1013, the common supply channels 18 communicating with the plurality of supply connection channels 323 and the common collection channels 19 communicating with the plurality of collection connection channels 324 are formed.

In the present embodiment, the ink flowing from the circulation unit 54 flows from the common supply channel 18, passes through the connection channel 1014, and flows to the common collection channel 19 and then to the circulation unit, generating macrocirculation 1012. This makes it possible to suppress ink concentration and precipitation in these channels. The ink flowing from the circulation unit 54 may also flow into the individual channels 1002, but the amount thereof is small and does not affect the evaporation speed from the ejection ports 13. In the individual channels 1002, microcirculation 1011 is generated by the liquid sending elements 1001, making it possible to suppress the ink concentration in the pressure chambers 12.

In the present embodiment, the macrocirculation 1012 is actively guided to the connection channels 1014, instead of the individual channels 1002. Thus, the ink evaporation from the ejection ports 13 can be suppressed. Also, as in the first embodiment, the influence on the individual channels 1002 can be suppressed by generating the macrocirculation 1012 at the required timing.

In addition to the above-mentioned channel configuration, as illustrated in FIG. 22B, common channels 1014 may be formed by the second substrate 1009 so as to connect to the plurality of supply connection channels 323 and collection connection channels 324 formed by the first substrate 1008. Also in this case, the configuration is such that the macrocirculation is generated as above. cl Third Embodiment

A circulation configuration in a third embodiment of the present disclosure will be described. Only differences from the circulation configurations in the first and second embodiments will be described.

### Circulation Path in Ejection Module

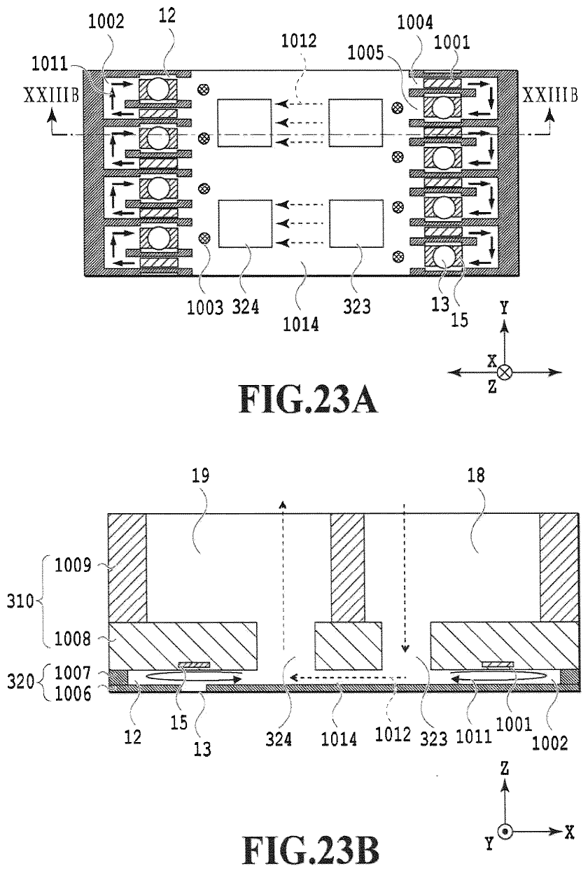

FIG. 23A is a partially enlarged view of an ejection module 300 of the present embodiment as seen along the ejection direction. FIG. 23B is a cross-sectional view taken along the line XXIIIB-XXIIIB in FIG. 23A.

In a nozzle plate 1006, ejection ports 13 for ejecting the ink are formed near its one end and the other end in the X direction. These ejection ports 13 are arrayed in the Y direction. Two ejection port arrays are arranged at positions shifted from each other by a half pitch in the Y direction.

In an individual channel layer 1007, U-shaped individual channels 1002 are formed at positions corresponding to the respective ejection ports 13. Moreover, in the individual channel layer 1007, connection channels 1014 are formed, which communicate in common with the plurality of individual channels 1002 and connect the supply connection channels 323 and the collection connection channels 324.

In a first substrate 1008, ejection elements 15 for generating energy for ejecting the ink are formed at positions included in each U-shaped individual channel 1002 and facing the ejection ports 13. In addition, in the first substrate 1008, liquid sending elements 1001 for circulating the ink in the U-shaped individual channels 1002 are formed at positions included in each individual channel 1002. In the present embodiment, the plurality of ejection elements 15 and the plurality of liquid sending elements 1001 are arranged alternately in a line along the Y direction. In the first substrate 1008, supply connection channels 323 capable of supplying the liquid commonly to the plurality of individual channels 1002 and collection connection channels 324 capable of collecting the liquid commonly from the plurality of individual channels 1002 are formed.

In a second substrate 1009, common supply channels 18 communicating with the supply connection channels 323 and common collection channels 19 communicating with the collection connection channels 324 are formed.

The individual channels 1002 are each a channel formed in a U-shape by the nozzle plate 1006, the individual channel layer 1007, and the first substrate 1008. The individual channel 1002 includes an individual supply channel 1004 on the ink supply side and an individual collection channel 1005 on the ink collection side. Such individual channels 1002 are formed near one end and the other end in the X direction.

In the U-shaped individual channel 1002, the liquid sending element 1001 is disposed on the individual supply channel 1004 side at a predetermined distance from the ejection element 15. The liquid sending element 1001 of the present embodiment generates thermal energy to circulate the ink in the individual channel 1002. As the liquid sending elements 1001 are driven, the ink is heated and sent out by film boiling of the ink. This allows microcirculation 1011 to be generated in the individual channel 1002. However, as in the first embodiment, a piezoelectric actuator (piezo element) may be used for the ejection element 15 and the liquid sending element 1001.

According to the configuration of the present embodiment, macrocirculation formed by the circulation units 54 flows mainly through the supply connection channels 323, the connection channels 1014, and the collection connection channels 324 in this order, and does not easily enter the U-shaped individual channels. In this way, by making the U-shaped individual channels 1002 less affected by the macro circulation 1012, ink evaporation from the ejection ports 13 can be suppressed. Also, as in the first embodiment, the influence on the individual channel 1002 can be suppressed by generating the macrocirculation 1012 at the required timing.

### Fourth Embodiment

A circulation configuration in a fourth embodiment of the present disclosure will be described. Only differences from the circulation configurations in the first, second, and third embodiments will be described.

### Circulation Path in Ejection Module

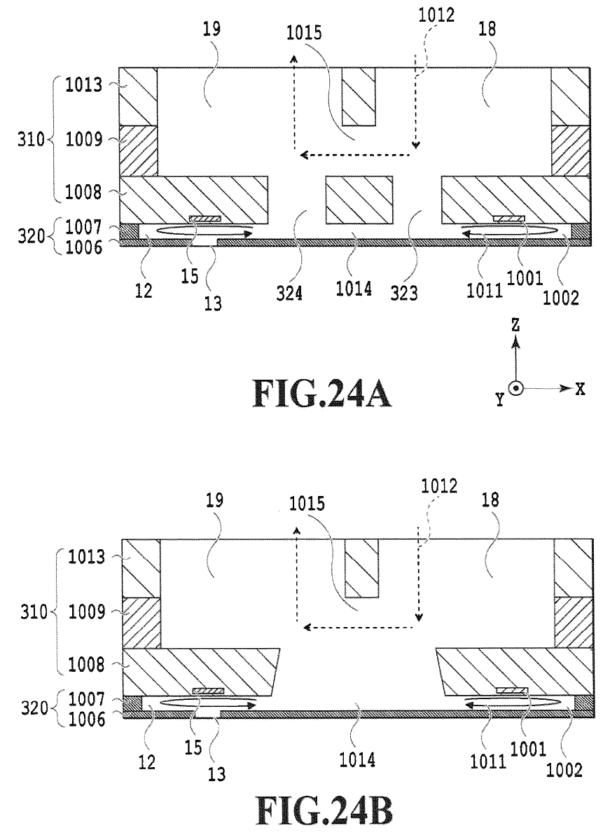

FIG. 24A is a schematic cross-sectional view of an ejection module 300 of the present embodiment. The ejection module 300 of the present embodiment has a configuration in which a nozzle plate 1006 to form ejection ports 13, an individual channel layer 1007 to mainly form individual channels, a first substrate 1008, a second substrate 1009, and a third substrate 1013 are laminated in this order in the Z direction. The structure of the ejection module 300 and the flow of the ink in the circulation channel will be described below. Note that the arrows in FIG. 24A indicate the flow direction of the ink.

In the individual channel layer 1007, U-shaped individual channels 1002 are formed at positions corresponding to the respective ejection ports 13. In addition, in the individual channel layer 1007, connection channels 1014 connecting supply connection channels 323 and collection connection channels 324 are each formed between two ejection port arrays. The connection channel 1014 will be hereinafter referred to as the first connection channel 1014 in the present embodiment.

In the first substrate 1008, ejection elements 15 for ejecting the ink, liquid sending elements 1001 for circulating the ink, the supply connection channels 323, and the collection connection channels 324 are formed in the same manner as in the third embodiment.

In the second substrate 1009, second connection channels 1015 directly connecting common supply channels 18 and common collection channels 19 are formed. In the third substrate 1013, the common supply channels 18 communicating with the supply connection channels 323 and the second connection channels 1015 and the common collection channels 19 communicating with the collection connection channels 324 and the second connection channels 1015 are formed.

In the present embodiment, the ink flowing from the circulation unit 54 mainly flows from the common supply channel 18 through the second connection channel 1015 to the common collection channel 19 and returns to the circulation unit 54, generating macrocirculation 1012. Part of the ink flowing from the circulation unit 54 flows from the common supply channel 18 to the common collection channel 19 through the supply connection channel 323, the first connection channel 1014, and the collection connection channel 324. In the individual channels 1002, on the other hand, microcirculation 1011 is generated by the liquid sending elements 1001. This makes it possible to suppress ink concentration and ink precipitation in the individual channels 1002.

Note that the configuration may be such that only one connection channel is formed by the first substrate as illustrated in FIG. 24B. However, the configuration in FIG. 24A is preferable to that in FIG. 24B because the macrocirculation path easily reaches an ejection port formation substrate 320.

Thus, according to the configuration of the present embodiment, the ink evaporation can be suppressed by adopting the configuration with as little macrocirculation 1012 as possible in the individual channels 1002. Also, as in the first embodiment, the ink evaporation in the individual channels 1002 can be suppressed by generating the macrocirculation 1012 at the required timing.

### Fifth Embodiment

A circulation configuration in a fifth embodiment of the present disclosure will be described. Only differences from the circulation configurations in the first to fourth embodiments will be described.

### Circulation Path in Ejection Module

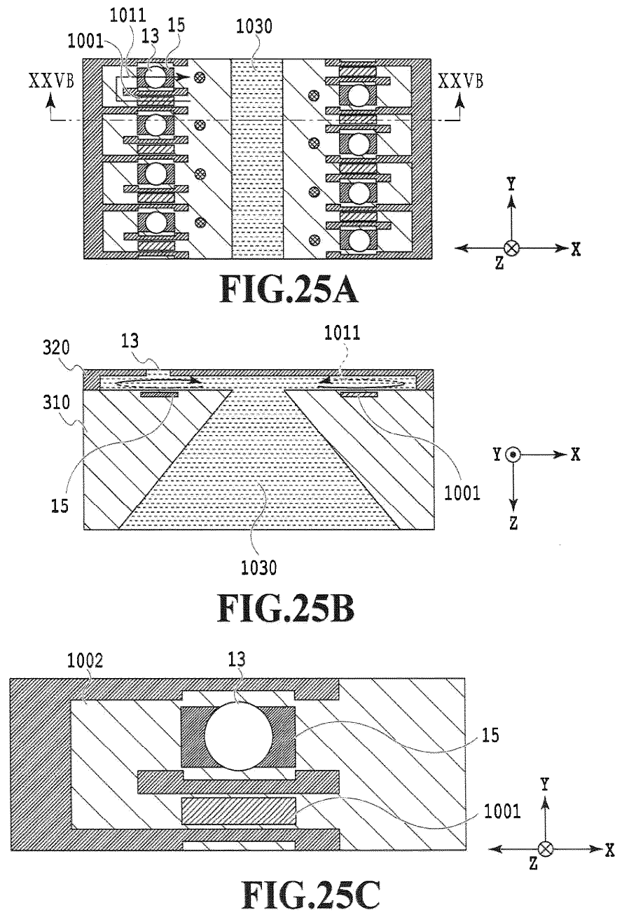

FIG. 25A is a partially enlarged view of an ejection module 300 of the present embodiment as seen along the ejection direction. FIG. 25B is a cross-sectional view taken along the line XXVB-XXVB in FIG. 25A. FIG. 25C is a partially enlarged view of FIG. 25A.

The ejection module 300 of the present embodiment has a configuration in which an ejection port formation substrate 320 to form ejection ports 13 and a silicon substrate 310 including ejection elements 15 and liquid sending elements 1001 are laminated in this order in the Z direction. The structure of the ejection module 300 and the flow of the ink in the circulation channel will be described below. Note that the arrows in FIGS. 25A and 25B indicate the flow direction of the ink.

The silicon substrate 310 is provided with a supply groove 1030 for supplying the ink to the individual channels 1002. The supply groove 1030 is formed in a tapered shape from the silicon substrate 310 toward the ejection port formation substrate 320. The ink supplied from the supply groove 1030 is supplied to the individual channels 1002.

The ejection module 300 of the present embodiment does not have a common channel for collecting the ink flowing out of the plurality of individual channels 1002. The ink flowing out of the individual channels 1002 flows back into the individual channels 1002 or moves toward the supply groove 1030. Part of the ink in the supply groove 1030, on the other hand, is recovered by the circulation unit 54. With this configuration, most of the ink flowing from the circulation unit 54 returns to the circulation unit 54 without being supplied from the supply groove 1030 to the individual channels 1002. In the individual channels 1002, on the other hand, microcirculation 1011 is generated by the liquid sending elements 1001, making it possible to suppress ink concentration and ink precipitation.

As described above, by circulating the macrocirculation 1012 at the required timing, it is possible to appropriately suppress the ink concentration and ink precipitation while suppressing the ink evaporation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-170891, filed Sep. 30, 2024, which is hereby incorporated by reference herein in its entirety.

What is claimed is:

1. A liquid ejection head configured to eject a liquid from an ejection port while moving in a predetermined direction, comprising:
an ejection unit including
an ejection element configured to generate energy for ejecting the liquid from the ejection port,
a pressure chamber communicating with the ejection port,
an individual supply channel for supplying the liquid to the pressure chamber, an individual collection channel for collecting the liquid from the pressure chamber, and
a liquid sending element disposed between the individual supply channel and the individual collection channel and configured to send the liquid from the individual supply channel to the individual collection channel; and
a circulation unit fluidly connected to the ejection unit and configured to circulate the liquid in a common supply channel for commonly supplying the liquid to a plurality of the individual supply channels, wherein
the circulation unit is driven on demand based on a predetermined condition determination.

2. The liquid ejection head according to claim 1, wherein the circulation unit constitutes a path for circulating the liquid only within the liquid ejection head.

3. The liquid ejection head according to claim 1, wherein the circulation unit has a pump for circulating the liquid.

4. The liquid ejection head according to claim 3, wherein the pump is a piezoelectric diaphragm pump.

5. The liquid ejection head according to claim 1, wherein the individual supply channel, the liquid sending element, the pressure chamber, and the individual collection channel are arranged in a line along the predetermined direction.

6. The liquid ejection head according to claim 1, wherein the individual supply channel, the liquid sending element, the pressure chamber, and the individual collection channel are arranged in a U-shape.

7. The liquid ejection head according to claim 1, wherein the circulation unit circulates the liquid by sending a liquid in a common collection channel for commonly collecting the liquid from a plurality of the individual collection channels to the common supply channel.

8. The liquid ejection head according to claim 7, further comprising:
a connection channel connecting the common supply channel and the common collection channel without passing through the pressure chamber, wherein
the circulation unit includes a channel for sending the liquid through the common supply channel, the connection channel, and the common collection channel in this order.

9. The liquid ejection head according to claim 1, further comprising:
a temperature adjustment mechanism for adjusting a temperature of the liquid near the pressure chamber.

10. The liquid ejection head according to claim 1, wherein the liquid sending element is driven intermittently to generate an intermittent flow of liquid from the individual supply channel to the individual collection channel.

11. The liquid ejection head according to claim 1, wherein
the ejection unit has a configuration in which
a nozzle plate having the ejection port formed therein,
an individual channel layer in which the pressure chamber, the individual supply channel, and the individual collection channel are formed,
an element substrate in which the ejection element and the liquid sending element are disposed, and
a common channel substrate in which the common supply channel is formed are laminated.

12. The liquid ejection head according to claim 11, wherein the common channel substrate has a common collection channel formed therein to commonly collect the liquid from a plurality of the individual collection channels.

13. The liquid ejection head according to claim 12, wherein
a second common channel substrate is laminated between the element substrate and the common channel substrate, the second common channel substrate having a connection channel formed therein to connect the common supply channel and the common collection channel without passing through the pressure chamber.

14. The liquid ejection head according to claim 11, wherein the liquid sending element is an electrothermal conversion element.

15. The liquid ejection head according to claim 11, wherein the liquid sending element is a piezoelectric actuator.

16. A liquid ejection apparatus comprising:
a scanning unit configured to scan a carriage, on which the liquid ejection head according to claim 1 is mounted, in the predetermined direction;
a conveyance unit configured to convey a sheet, onto which droplets ejected by the liquid ejection head are applied, in a direction intersecting with the predetermined direction; and
a control unit configured to control an ejection scanning unit, the conveyance unit, the circulation unit, the ejection element, and the liquid sending element.

17. The liquid ejection apparatus according to claim 16, further comprising:
a printing unit having a program stored therein to be executed by the control unit, wherein
the control unit performs the predetermined condition determination according to the program, and drives the circulation unit based on a determination result.

18. A method for controlling a liquid ejection head configured to eject a liquid from an ejection port while moving in a predetermined direction, the liquid ejection head including:
an ejection unit including
an ejection element configured to generate energy for ejecting the liquid from the ejection port,
a pressure chamber communicating with the ejection port,
an individual supply channel for supplying the liquid to the pressure chamber, an individual collection channel for collecting the liquid from the pressure chamber, and
a liquid sending element disposed between the individual supply channel and the individual collection channel and configured to send the liquid from the individual supply channel to the individual collection channel; and
a circulation unit configured to circulate the liquid in a common supply channel for commonly supplying the liquid to a plurality of the individual supply channels,
the method comprising:
driving the circulation unit on demand based on a predetermined condition determination.
